(19) United States
(12) Patent Application Publication
(10) Pub. No.: US 2005/0097017 A1
(43) Pub. Date: May 5, 2005

(54) Financial funding system and methods

(76) Inventor: Patricia Hanratty, Swansea, MA (US)

Correspondence Address: Cook Alex McFaron Manzo;Cumming & Mehler, Suite 2850, 200 West Adams Street, Chicago, IL, 60606, US

(21) Appl. No.: 10/480,399

(22) PCT Filed: Nov. 1, 2002
(86) PCT No.: PCT/US02/35195

Related U.S. Application Data
(60) Provisional application No. 60/336,228, filed on Nov. 2, 2001.

(51) Int. Cl. G06F 17/60

(52) U.S. Cl. 705/35; 705/38

(57) ABSTRACT

A financial funding system facilitates internet funding by a parent of a plurality of financial accounts that are set up for a student at a university. Preferably, the accounts correspond to expense items at the university such as tuition, bookstore, meals, and the like. A client presentation layer communicates with the parent and student, a security layer authenticates users, a business logic layer manages the accounts, a data layer stores information about the parent, student, the accounts and records transfers. An internet payment engine transfers funds. Methods include receiving communications from the parent or student, authenticating registered users, providing access to the plurality of accounts by the parent to fund same and by the student to pay corresponding expense items of the university, transferring funds such as with an internet payment engine, maintaining and updating the accounts, issuing email notification of the transfer of funds, and funding of multiple students at multiple universities.

### CROSS-REFERENCE TO RELATED APPLICATION

This patent application is a non-provisional application of U.S. provisional patent application Ser. No. 60/336,228, filed on Nov. 2, 2001.

### BACKGROUND OF THE INVENTION

The present invention relates generally to online fund transfer and payment services and, more particularly, to systems and methods that utilize an internet payment engine and corresponding portal to enable funders to have greater flexibility and control over the funding of financial accounts and the payment of financial obligations.

Provision of financial services to students at universities affects three core constituencies: 1. the university, including its staff, 2. the students and 3. the parents, relatives, guardians or others (hereinafter “parents” or “funder”) that are providing part or all of the funding for any student's education. Each constituency has unique, but complementary needs. For example, university administrators face the most complex challenges of these three constituencies due to their need to facilitate funds transfers from parents to students and manage payment processing for core, non-academic services. They further need to manage and reconcile these fund transfers and receivables accounts. Still further, they need to facilitate access to on campus financial services for their students.

The universities are presented with payment processing challenges due to acceptance of funds into and tracking university “declining balance” and/or credit programs. These consume significant time and administrative resources throughout the university. A variety of university departments have separate processes and systems to meet similar account funding needs including, among others, tuition, boarding, food services, bookstores, athletic activities, financial services, and the like.

The universities are also presented with account management challenges. Among others, the university must manage the paper trail left behind by checks and credit card payments made on behalf of thousands of students throughout the year. The universities must further integrate and balance deferring programs and accounts. Still further, the universities must reconcile multiple independent accounts, payment systems and procedures.

The universities also face on-campus financial services challenges. Although universities are not generally in the banking business, university personnel often wish to assist students with accessing financial services. In particular, students arriving on campus for the first time often have little financial experience. Most do not have a bank account or ready access to cash or depository services.

In view of the foregoing, universities and colleges need assistance in organizing, funding and managing the range of campus programs funded by parents and students throughout the year. Universities can benefit from all components of the system of the present invention.

Students, the second core university constituency, typically do not have established banking patterns or relationships. Most current students are highly active in electronic commerce and/or the internet. While many current students do not have experience with financial services, such students would be more likely to accept widespread automated teller machine card and credit card usage. Current students who are in need of a banking account and/or relationship, are less likely to select their bank on location and are likely to utilize internet banking, including direct deposits and withdrawals.

Parents face several challenges in providing for the day-to-day financial needs of college students. Many students are away from home for the first time, but will remain financially dependent on their parents. As a result, parents need to quickly and easily provide spending money, allowances, pay for tuition, pay for books and supplies, fund meal plans and various other accounts. Often, universities may define sub-accounts for the various expenses that may be encountered or anticipated. Many parents also wish to know that funds provided for such specific needs are actually used for their intended purpose, and that the necessary payments have, in fact, been made.

It is a general object of the present invention to provide systems and methods that utilize an internet payment engine and a corresponding portal to enable funders to have greater flexibility and control over the funding of financial accounts and the payment of financial obligations, such as in a university environment.

Another object of the present invention is to provide a system and methods of online funding for the financial needs of university students.

Yet another object of the present invention is to provide a system and methods to reduce the time and resources required by a university to manage, process and track the financial transactions of the university students.

A further object of the present invention is to provide a system and methods of providing financial services to university students via electronic commerce and the internet.

A still further object of the present invention is to provide a system and methods for parents to conveniently fund the financial needs of students and to track financial transactions so that the parents can determine that the funds were used for the intended purposes.

Another object of the present invention is to provide a system and methods to enable parents to conveniently fund the financial needs of multiple students that may be enrolled in different universities.

### SUMMARY OF THE INVENTION

The systems and methods of the present invention are concerned with providing unique financial services for university communities, and are particularly applicable to financial accounts for university students that are directly or indirectly set up by the university. These systems and methods provide online funding of various expense items associated with a university, such as meal plans, bookstores, tuition, activities, personal expenses and other university programs. Preferably, a plurality of financial accounts are set up, one for each anticipated expense item. Parents can fund the accounts via the internet and students can issue payments from the accounts via the internet. These systems and methods thus provide financial services to three core university constituencies, including university administration and staff, the students and the parents.

The financial funding system includes a client presentation layer that communicates with the parents and the students and that provides appropriate screens for each step of the funding or payment processes. A security layer authenticates the parents and students as registered users of the system. A business logic layer manages the accounts and permits parents to add funds to selected accounts and permits students to make payments from the funded accounts. An internet payment engine electronically transfers funds into the accounts and transfers payments out of the accounts. A data layer stores information about the registered parents and registered students, keeps records of the accounts and any transfers of funds to or from the accounts, and may also store preference and configuration information. A notification layer may issue emails concerning any transfer of funds, such as to the parents and/or students.

The methods include receiving internet communications from the parents and students, authenticating the parents and students as authorized users of the system, providing access to a plurality of financial accounts for each student, receiving authorization for amounts to be transferred into or out of selected ones of the plurality of financial accounts, and transferring funds into or out of the selected accounts. The methods also include storing information about registered parents and students, keeping records of any fund transfers into or out of the accounts, setting up the accounts to fund corresponding expense items of the university, issuing email confirmations of any transactions to the parents and/or the students, maintaining and updating the financial accounts and using an internet payment engine to transfer the funds to or from the accounts. Yet another method concerns funding of multiple students enrolled at different universities.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures in which like reference numerals identify like elements, and in which:

FIG. 1 is diagrammatic view of the architecture of a system in accordance with the present invention;

FIG. 2 is a diagram further illustrating the design of the system in FIG. 1, including the interrelationships between the various parties.

FIG. 3 is a flow chart of the typical steps or methods employed by the system of FIGS. 1 and 2 when a parent accesses, funds or monitors the financial accounts of a student.

FIG. 4. is a flow chart of the typical steps or methods employed by the system of FIGS. 1 and 2 when a student accesses, issues payments or monitors his/her financial accounts.

FIG. 5 is a representative account statement that may be issued to a parent and/or student, such as by email, for one or more students.

FIG. 6 is a flow chart of the typical steps or methods employed by the system of FIGS. 1 and 2 when an authorized university administrator or staff member accesses, monitors and/or updates financial accounts.

### DESCRIPTION OF THE PREFERRED EMBODIMENTS

The systems and methods of the present invention are concerned with providing unique financial service needs for university communities, and are particularly applicable to financial accounts for university students that are directly or indirectly set up by the university. These systems and methods provide online funding of a student's university meal plans, bookstores, tuition, activities, personal expenses and other university programs. They further provides online student banking accounts with access to campus automated teller machines. Funding parties can fund the student bank accounts, such as by parents. These systems and methods thus provide financial services to three core university constituencies, including university administration and staff, students and parents. While parents might not normally be thought of as a university constituency, parents usually provide partial or total financial support for most students. Thus, for at least these purposes, parents are considered a constituency of the university. Each constituency has unique, but complementary needs, which are integrated into the program design.

With respect to these three core university constituents, the present invention satisfies the needs of all parties. Fast and automatic deposits may be made into multiple accounts without the need for intervention by the university administration or staff. Daily electronic feeds track deposits by student account type. The present invention significantly reduces reconciliation and account balancing work. Further, it facilitates automatic year end balance refunds. As will be appreciated by those skilled in the art, this translates into reduced administrative burdens for the university staff.

With respect to the students, the present invention permits students to have the ability to bank online and to have accounts funded by parents from their home locations. These campus accounts and automated teller machine cards can be funded more easily and quickly by parents by facilitating the transfer of funds from a computer located within the parent's home. Parents are thus enabled to fund specific student and/or university accounts online at their convenience. Transfers are fast, accurate and can be done through automated clearing house (ACH), credit card or other funding methods. The parents are assured that the funds will be used for their intended purposes.

Regarding the functionality of transfers and transactions, the present invention enables individuals to fund multiple, pre-defined individual and university accounts. Funding methods include any available, such as credit cards, ACH, electronic funds transfer (EFT), wire and other available funding methods. Transfers are preferably conducted online. As a backup, telephone transfers can be accepted.

Each transaction can be confirmed through messaging, as desired. As an example, individual electronic mail (email) messages confirming each transaction can be sent to both the parent/funder and to the student. Each such communication can detail the total amount transferred, the amount applied to each account, the date, time, and funding method for the transaction, and the remaining balances.

The systems and methods of the present invention include several website interfaces including a funder's portal on the front-end and an internet payment engine on the back-end. Further included are administrative interfaces.

The funder's portal permits funders to fund recipient's financial accounts or accounts of the university, including declining balance and credit accounts. Without limitation, a funder is understood to be a person, whether natural or juristic, who uses the system of the present invention to transfer funds to recipient(s), and more specifically to particular, established accounts of those recipients. Also without limitation, a recipient is understood to be a person who can receive funds through the service provided by the provider of these systems and methods and receives funds from one or more funders. An organization is one that has established financial accounts with recipients and that desires to ease its administrative burden related to those accounts by offering the services provided by a provider of financial services. An administrator is an employee, consultant or other person affiliated in some respect with the organization.

In a university setting of the type to which the present invention has particular applicability, a funder will usually be a parent, close relative or friend of a student attending a university. A recipient will ordinarily be a student who shall have established one or more accounts offered through the university, including a general banking or financial account (e.g. checking and/or savings account). The organization will be the university having several financial accounts with a financial institution, including general checking and savings accounts, meal plan accounts, tuition accounts, athletic fee accounts, bookstore accounts, financial aid accounts, and the like. The administrator is an employee of a university who manages student accounts payable information at the university.

The funder's portal will allow funders to fund student's debit cards and to pay for student's specific school expenses, such as tuition, meal plan, athletic and student store accounts, and the like, over the internet. The internet payment engine will provide the vehicle for permitting funds to be transferred or credited into these particular accounts from the funder's selected account. The administrative interfaces will allow financial institution and university staff to perform simple administrative and reporting tasks.

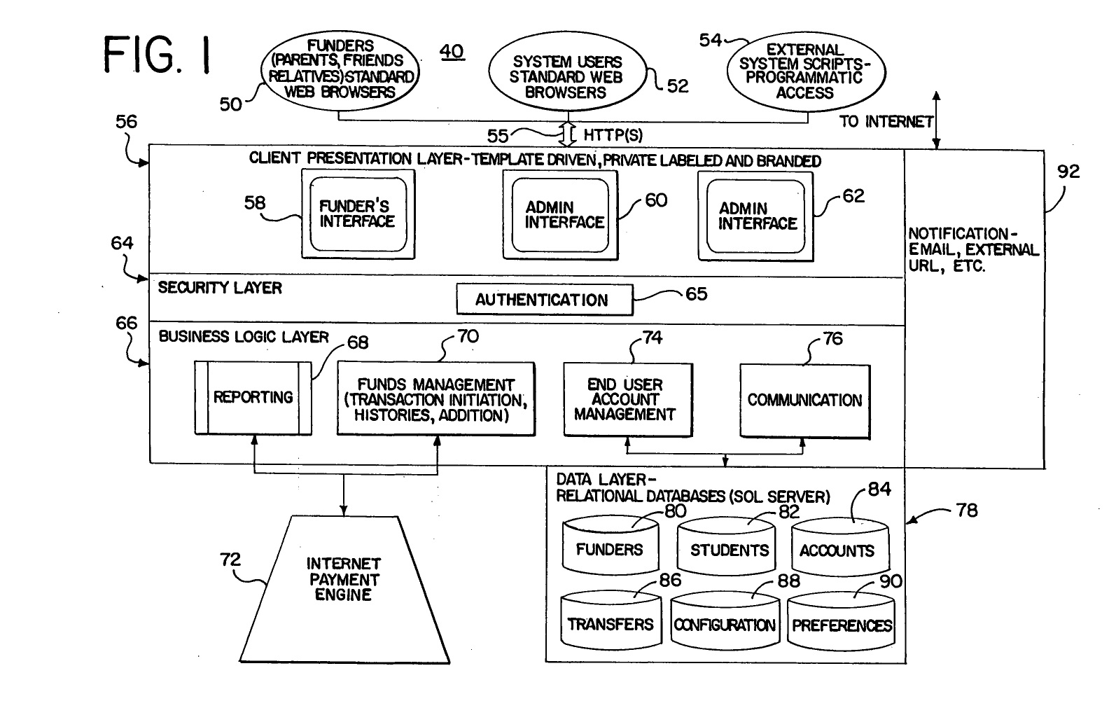

FIG. 1 illustrates a global view of a system, generally designated 40, in accordance with the present invention, including the system architecture that may be implemented in order to provide the desired functionality. It will be understood that FIG. 1 is representative of only one such system architecture or embodiment, albeit the preferred embodiment. Funders 50 may have access to system 40 through standard web browsers, such as from a computer at their home or place of business. In the university setting, the funders will typically be parents, relatives or friends of students attending the university.

System users 52, including the provider of the system and the organization that offers access of this system to users, such as students at a university. The provider of the system will ordinarily be a financial institution and the organization that offers access to the system will ordinarily be a university or other organization having multiple financial accounts. Reference numeral 54 refers to external system scripts and programmatic access to the system. This includes internet scripts and access into the system. System access is preferably obtained via a secured HTTP internet interface 55.

A client presentation layer, generally designated 56, is template driven, private labeled and branded according to the desires of the provider of the system. A funder's interface 58 may be a webpage interface for the funders at the client presentation layer 56. An organization/university administrative interface 60 is also included at the client presentation layer for accessing the system 40 by authorized university personnel, such as administrative and staff personnel. Further included at that layer is the financial institution administrative interface 62 for accessing system 40 by the personnel of a financial institution, such as a bank, that sets up and maintains the various accounts.

A security layer, generally designated 64, is further included within the system architecture illustrated in FIG. 1. Security layer 64 includes an authentication process 65 that authenticates that each user of system 40. For example, authentication process 64 determines whether funders, administrators, students or other authorized users are in the proper interface 58, 60, or 62. Authentication process 65 also validates entitlement to data streamed to that user. It further ensures the integrity, validity and authenticity of all data transmitted into system 40.

A business logic layer, generally designated 66, includes reporting 68 and funds management 70. Both are linked to an internet payment engine 72. Funds management 70 initiates transactions and provides transaction histories and the like. Within business logic layer 66, end user account management 74 and communication 76 are further shown. These blocks represent the functionality of reporting and statementing conducted by the system 40. The end user account management block 74 represents the management of end user accounts and ensures the integrity of the user database.

Blocks 74 and 76 are linked to the data layer, generally designated 78, that includes relational databases for funders 80, for students 82, for accounts 84, for transfers 86, for configuration 88, and for user preferences 90. The transfers database 86 relates to transfers between accounts for particular funders and recipients.

A notification layer 92 representing electronic mail communication, external uniform resource locator (URL) communication, and the like, identifies those processes wherein the student and/or parent receives emails upon completion of a transaction. It further represents the reports that are generated and delivered to the appropriate administrator of the program for the organization and to the appropriate funder for each transaction, as desired. This reporting is completed automatically upon completion o of a transaction. Communication through notification layer 92 is preferably directed in a single direction only. In that regard, all communication into the system data layer 78 preferably passes through security layer 64. All incoming traffic preferably passes through the client presentation layer 56 and the security layer 64.

The preferred hardware used to implement the present invention may be a three-server configuration, including a web/application server, a database server, and a backup web/application/database server. The database server, is preferably controlled by software that provides real-time synchronization of data between the primary database server and the backup database server. This allows for instant and seamless restoration of service in the event of an outage on the primary database server. Under such circumstances, backup is provided and there is not any serious risk of data loss. An appropriate internet payment engine 72 also needs to be implemented with the architecture, as shown in FIG. 1, and may be provided by a third party vendor.

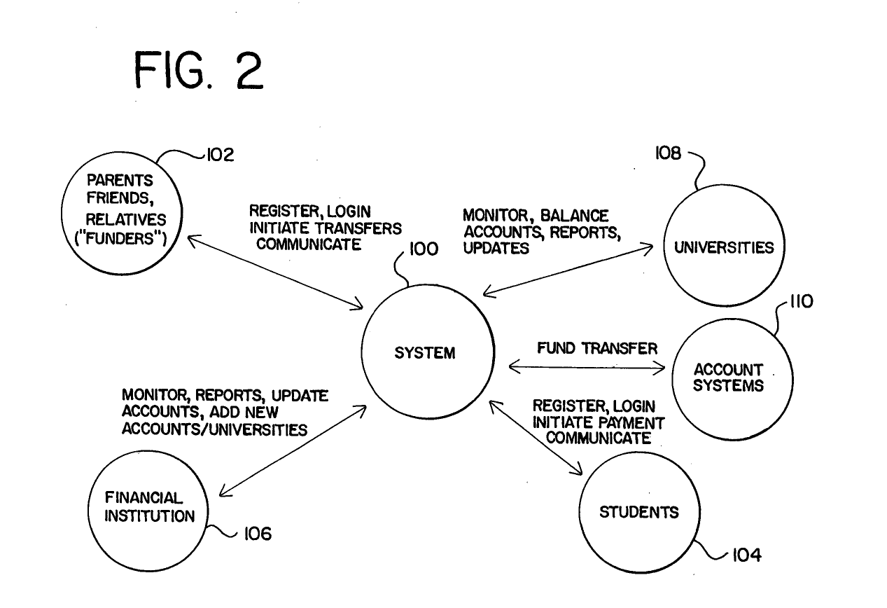

FIG. 2 illustrates a hub-and-spoke conceptual design of the system in accordance with the present invention. The system itself is identified by reference numeral 100. Funders are identified by block 102 and are shown to register, log in, initiate transfers and otherwise communicate with system 100. The recipients, or students, identified by block 104, are able to register, log in, initiate payments from various funded accounts, and otherwise communicate with system 100. A financial institution is represented by block 106 and is shown to monitor accounts and update them, as necessary. The financial institution 106 further reports on the accounts and adds and deletes organizations and accounts set up for the same, as necessary. Block 108 represents a participating organization, such as a university, that monitors and balances accounts. The university 108 may issue reports, update accounts and provide certain functionality with respect thereto.

Block 110 in FIG. 2 represents an internet payment engine that carries out the fund transferring functions of the system of the present invention. This system is designed to be a unified system that will serve the financial needs of these end-users in a consistent and efficient manner. For example, this system will preferably keep a running total of the funded dollar amounts from parents 102 to be added to all accounts, including specific sub-accounts, for each student 104, and a running total of the transferred dollar amounts to be deducted from the appropriate accounts or sub-accounts for each student 104, the amounts to be debited or credited to each personal financial institution 106 account, and the payments to be credited to the various accounts at the universities 108.

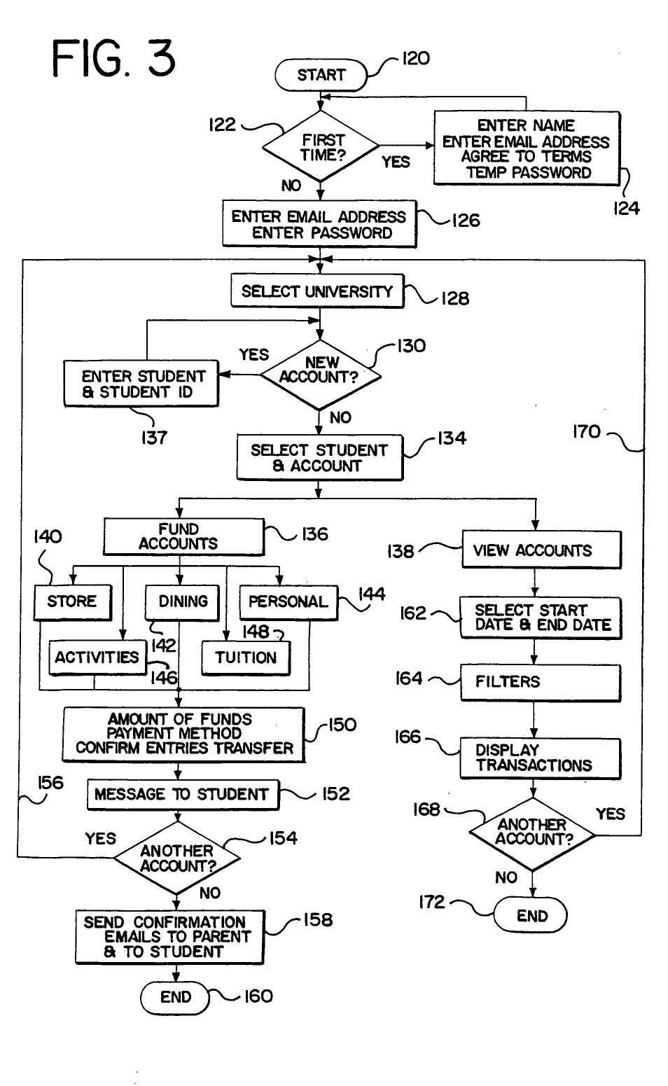

FIG. 3 illustrates the methods and procedures for transferring funds from a funder's account to an account or accounts for one or more students that the funder desires to fund. Similar methods may also be used for transferring funds from a funder's account to the accounts of an organization, such as a university. A valid funder starts at block 120 by logging onto the system. Logging on may be accomplished by first logging onto the homepage of the appropriate university, the homepage of the affiliated financial institution 108 (FIG. 2), the homepage of the organization that develops and markets the system (such as www.CampusMate.com) or by using any other URL that has access to the desired account information. If the system does not recognize the internet address of the funder's computer, as at block 122, the system may request that the funder register on the system. This is done, for example at block 124 by entering a name and an email address. Preferably, the funder's email address may also serve as the funder's name in the default mode. The funder may be requested to agree to the terms associated with using the system. Upon agreement, the funder may be assigned a temporary password, with a permanent password to be sent to the funder at a later time such as by email.

If the funder is already a registered user of the system, the funder may be requested to enter certain information such as the user's email address and/or a password, as at block 126. Since the system facilitates financial transactions, at least a password is ordinarily required. If the funder has more than one student at different universities, the funder may be requested to select a university at block 128. If the funder logged on at a specific university, that university may be used as the default choice. A pull-down menu that has a listing of all the participating universities may accomplish this, for instance. Alternatively, the system upon registration of the funder, may list the students previously associated with the funder during a prior registration and request that the funder select one of the students, such as by a pull down menu or any other suitable means. However, if the funder is new to the system, he/she may be prompted at block 130 to enter the appropriate student information, as at block 132. Thereafter, blocks 130 and 132 may be bypassed unless the funder seeks to add new student information to the system. Upon selection of a university, the system will preferably display the students and accounts associated with any particular funder.

Each participating university preferably has its own landing page hosted at a particular landing page URL web address. Popup windows, hyperlinks and the like will permit a funder to initiate fund transfers to a student's general account or accounts that are set up for the student's participation in certain school programs. The funder may choose to have control over how his/her money is used by funding the appropriate sub-accounts with fund transfers in the appropriate or recommended amounts.

The system may then prompt the funder to select a student, as at block 134. The system may recall the student's account number, or request that the funder enter the account number as a further security measure. If further security is desired, the system may also employ personal identification numbers (PINs). The system may present choices to the funder, such as to fund accounts at block 136, to view accounts at block 138, or others. If the funder selects to fund the accounts at block 136, a plurality of different accounts or sub-accounts may be displayed. Also preferably displayed are current balances in each account, such as in the sub-accounts identified in blocks 140-148. It will be understood that the number of sub-accounts and the identity of the sub-accounts may be selected or suggested by each university and therefore may differ from university to university. Some flexibility may also be given to funders to set up certain accounts, such as the personal account 144, which may be used to cover incidental expenses, entertainment, and the like for the student. For example, additional accounts could also be added for dormitory expenses, for laboratory expenses for those courses with laboratory fees, for vehicle permits and/or parking, and the like.

As indicated at block 160, after accessing the plurality of sub-accounts 140-148, the funder can select one or more of the accounts for adding funds. The funder will be requested to enter an amount to be added to each selected fund. After entering the amounts of funds, as at block 150, the funder will need to enter a payment method, which may include a transfer from an identified bank account, a debit to a debit card, or the like. Such funding preferences may have been set up in a prior registration. The funder may then be prompted to confirm the funding entries for the various accounts before selecting to activate the funds transfer process, such as by clicking a “send” button. Prior to completing the transaction, funder may alter previous choices or entered amounts, and the system may prompt the funder to change entries that appear to be erroneous. The system may also be set up to enable the funder to designate a recurring scheme of funding in which the funds are transferred at a particular time at regular, and/or preselected, intervals, such as weekly, monthly or on a particular day of a given week or month. Any available recurring scheme could then be selected.

Following completion of the funding steps at block 150, the funder may be invited to send an email to the student, as indicated at block 158. Typically, this messaging option is used to notify the student that additional funds have been transferred to specific accounts, the amount of new funding for each account and the new balance in each account. Other messages may be added to this account information. However, if a message is not elected at block 154, the system will provide a default email message to the funder and the student to confirm the funding transaction and to provide the new balances in the respective accounts, as indicated in block 158.

Prior to ending the funding process, the funder may be prompted at block 154 concerning additional accounts. Typically, this would be for another student who may be at the same university or another university. If another account is selected the process continues, as by returning the funder via line 156 to block 128.

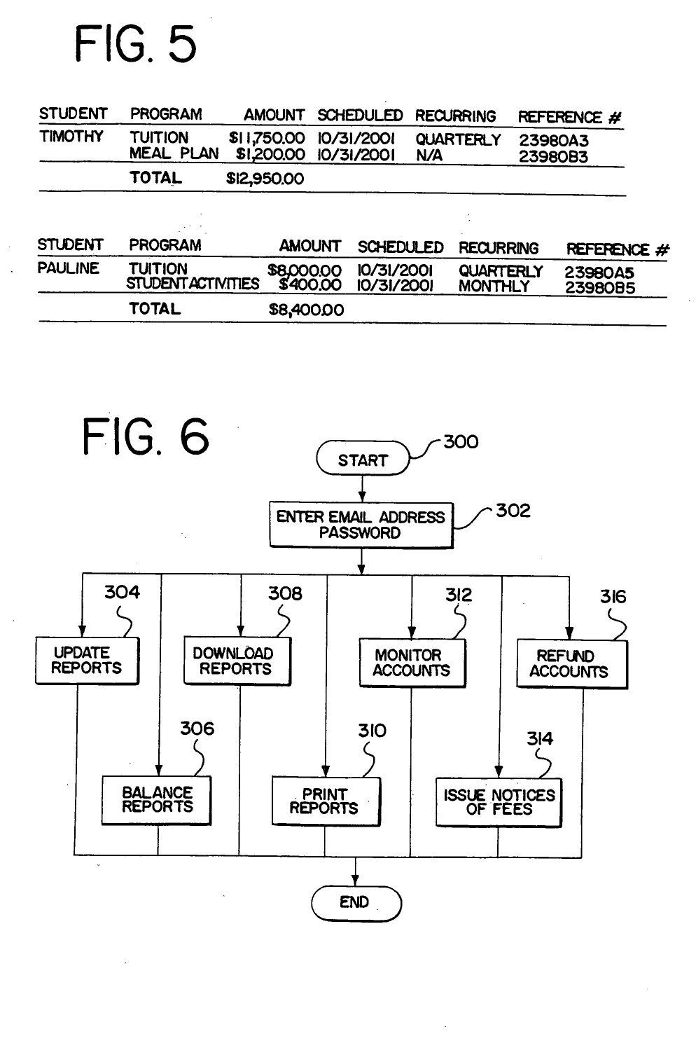

If the funder previously elected to view the accounts, as at block 138, the funder will ordinarily be requested to enter a range of dates, such as a starting and ending date, as shown in block 162. Alternately, the funder may select the past month, the past 100 days or the like. For example, entry of specific date ranges can be accomplished by typing the starting and ending dates into appropriate fields, or alternately using pop-up monthly calendars having date cells that may be selected. The user then clicks the desired dates on the monthly calendars to populate the start/end date fields. The funder may be able to filter the information, as indicated at block 166, such as by selecting or deselecting certain fields of information. The system then displays the account information in the format chosen and for the selected time period, as indicated at block 166. For example, account information may be displayed in the format shown in FIG. 5. While electronic transfers of funds within this system may be nearly instantaneous, other transfers, such as from a funder's account into accounts within the system, such as to sub-accounts 140-148, may take a matter of days in some instances. The displayed account information shown in FIG. 5 may therefore contain another field, such as status, to indicate if a previous transaction is pending, completed, denied or the like.

When the funder finishes viewing the selected transactions, he/she may elect to view other student accounts at block 168, such as by returning via line 170 to block 128. While the fund accounts 136 and the view accounts 138 steps in the example of FIG. 3 are shown separately with returns to block 128, other means of alternating between these functions may be utilized. For example, the internet pages associated with these steps may have tabs, buttons, directories or the like, that may be actuated to immediately transfer from one step to the next desired step without routing back through block 128. Similar functionality may be also be implemented for other blocks shown in FIG. 3.

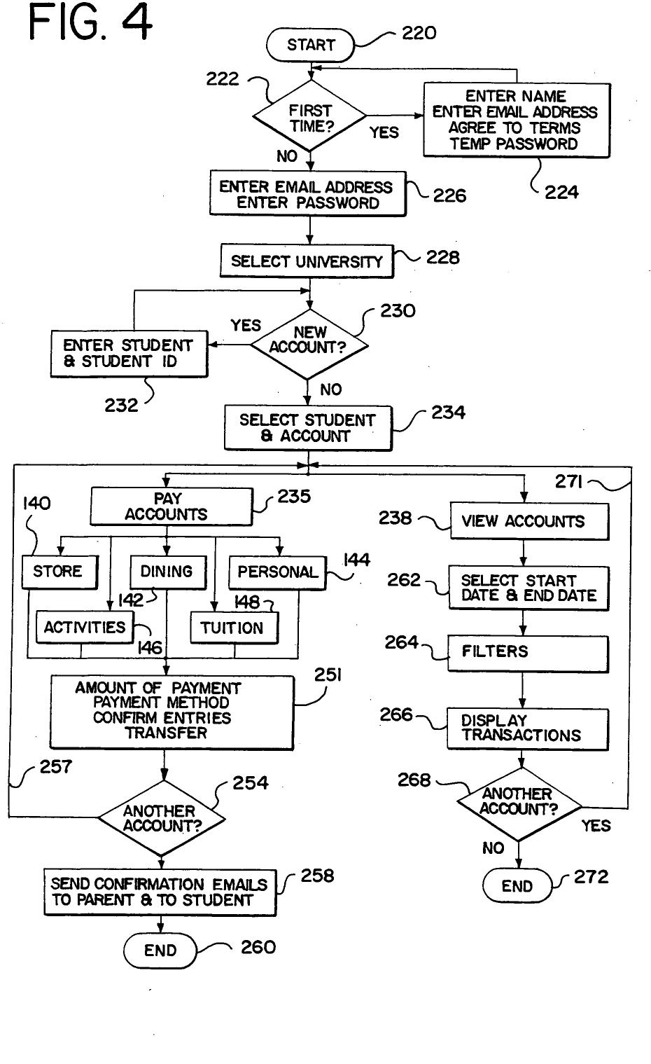

FIG. 4 illustrates the methods and procedures that a student utilizes to issue payments, or to otherwise transfer funds, from the funded accounts. Corresponding reference numerals to those in FIG. 3 are used in FIG. 4 for corresponding steps. For example, the start block 120 in FIG. 3 corresponds in general functionality to the start block 220 in FIG. 4. Note that accounts 140-148 are numbered identically in FIGS. 3 and 4 since these are the same accounts in both Figures. Because many steps are so similar and for the same purposes, the above descriptions of the various blocks for FIG. 3 will be incorporated by reference for FIG. 4.

Some of the more significant differences in the flow chart of FIG. 4, as compared to FIG. 3, will be presented. For example, the use of the system by the student in FIG. 4 may be expected to be primarily to issue payments, to transfer funds, or to withdraw funds from the respective accounts, instead of funding the accounts as by the funder in FIG. 3. The select university block 228 will be bypassed by many students logging onto a university page because the participating university is already selected by default. Another important difference between the flow charts of FIGS. 3 and 4 is that the fund accounts block 136 in FIG. 3 now best corresponds to the pay accounts block 235 in FIG. 4. This enables students to access accounts 140-148 to pay expenses at the university from any of the plurality of accounts. Accordingly, block 251 requires the student to enter the amount of desired payment from each account 140-148. Ordinarily, the method of payment would be by transfer of funds from one or more of accounts 140-148, but other payment methods may also be implemented such as from a debit card, or the like, that may be associated with accounts 140-148 or from a separate account, such as at an affiliated bank.

Another difference between FIGS. 3 and 4 is that there is no block in FIG. 4 that corresponds to block 152 in FIG. 3 where the funder can send a message to the student after transferring funds into one or more of the accounts 140-148. Also, decision block 254 may return to the account information by line 257, compared to block 154 in FIG. 3 returning to block 128. This is because the student only has access to his/her accounts, as compared to a funder that may have access to the accounts of more than one student. Similarly, decision block 268 in FIG. 4 may return to the account information by line 271, compared to decision block 168 returning to block 128 in FIG. 3.

While FIGS. 3 and 4 illustrate preferred methods of practicing the present invention, it will be appreciated from the foregoing description that many variations of these methods may be implemented while retaining the benefits of the invention. For example, the sequence of certain blocks may be changed, new blocks representing new steps may be added, the functions of some blocks may be combined, and/or some blocks may be deleted. As one example, blocks 130 and 132 for entering new accounts and other new student information might be combined with the other initial registration steps in blocks 122 and 124.

A typical flow chart for a university is illustrated in FIG. 6. An authorized administrator or staff member of the university gains access to the system by entering an email address and a password, as at block 302. The university administrator then gains access to a plurality of functions or operations, such as those shown in blocks 304-316. The administrator may be able to update the financial reports at block 304, balance the financial reports at block 306, download the financial reports at block 308 and monitor the reports at block 312. These activities may be done on a daily basis, a weekly basis, a monthly basis, and/or all of the above, as desired. Of course, the university could delegate some or all of these tasks to the financial institution, or an accounting firm, as desired. Any of the reports may be printed at block 310. The university may also issue notices of fees due, such as for tuition or other fees, at periodic interval, as indicated in block 314. At the end of the current term, semester or school year, the university may refund the amounts remaining in the accounts, such as in sub-accounts 140-148. Otherwise, the students may be permitted to transfer the remaining balances back to the funder's account.

The financial institution will typically set up and maintain the plurality of financial accounts for each student. Debit cards, credit cards, or the like, may also be issued by the financial institution to provide student access to automated teller machines (ATMs) on the campus of the university for the financial convenience of the students. For example, students may be able to withdraw funds from a personal account, such as block 144 in FIG. 3, for day-to-day expenses.

While the present invention is described as being applicable to a university or college environment, and while it is well-suited for use in that application, it will be appreciated that it is not limited to such use and has more widespread application.

While particular embodiments of the invention have been shown and described, it will be obvious to those skilled in the art that changes and modifications may be made therein without departing from the invention in its broader aspects.

### REFERENCE TO A COMPUTER PROGRAM LISTING APPENDIX

Applicant hereby incorporates by reference the material on a compact disk; two copies of which are filed herewith. This incorporation by reference is made under 37 C.F.R. 1.52(e)(5). The files on each compact disk are specified below:

| Name | Modified | Size |
|---|---|---|
| act_ExpireSession.cfm | 6/27/2002 1:30 PM | 1,492 |
| act_GetAccountNumber.cfm | 6/19/2002 10:46 AM | 597 |
| act_JWUStudentDatabaseRe . . . | 8/21/2002 9:49 AM | 2,372 |
| act_{—} | 9/3/2002 1:48 PM | 2,389 |
| LyonsRoutingNumberRe . . . | | |
| act_PickYourSchool.cfm | 6/19/2002 3:27 PM | 1,136 |
| act_SaveSession.cfm | 6/19/2002 10:46 AM | 1,253 |
| act_SendMail.cfm | 7/19/2002 2:26 PM | 5,835 |
| dsp_128bitEncrypt.cfm | 6/19/2002 10:46 AM | 1,272 |
| dsp_About.cfm | 6/19/2002 10:46 AM | 1,766 |
| dsp_CampusMateHome.cfm | 7/19/2002 8:28 AM | 9,111 |
| dsp_CookiesAreRequired.cfm | 6/19/2002 10:46 AM | 1,161 |
| dsp_FAQ.cfm | 7/16/2002 8:26 AM | 22,867 |
| dsp_FormErrors.cfm | 7/8/2002 12:52 PM | 1,390 |
| dsp_InvalidSectionError.cfm | 6/19/2002 10:46 AM | 541 |
| dsp_JavaScriptDisabled.cfm | 6/19/2002 10:46 AM | 1,107 |
| dsp_JWUFAQ.cfm | 7/24/2002 4:50 PM | 30,286 |
| dsp_NotFound.cfm | 6/19/2002 10:46 AM | 1,394 |
| dsp_PickYourSchool.cfm | 6/19/2002 10:46 AM | 2,706 |
| dsp_PressRelease1.cfm | 6/19/2002 10:46 AM | 6,334 |
| dsp_PressRelease2.cfm | 6/19/2002 10:46 AM | 2,739 |
| dsp_PressRelease3.cfm | 6/19/2002 10:46 AM | 4,769 |
| dsp_PressReleaseDetails.cfm | 7/7/2002 8:32 AM | 2,257 |
| dsp_PressReleases.cfm | 7/7/2002 8:31 AM | 3,197 |
| dsp_PrivacyPolicy.cfm | 6/19/2002 10:46 AM | 6,000 |
| dsp_SchoolLanding.cfm | 7/24/2002 4:50 PM | 5,226 |
| dsp_ServerError.cfm | 6/19/2002 10:46 AM | 1,234 |
| dsp_SessionTimedOutError . . . | 6/19/2002 10:46 AM | 576 |
| dsp_TuitionFAQ.cfm | 6/25/2002 4:36 PM | 1,291 |
| fbx_Circuits.cfm | 9/9/2002 2:11 PM | 1,049 |
| fbx_Errors.cfm | 7/22/2002 9:16 AM | 1,710 |
| fbx_fusebox30_CF50_nix.cfm | 6/19/2002 10:46 AM | 21,182 |
| act_AuthenticateUser.cfm | 7/11/2002 7:21 PM | 1,738 |
| act_CheckLoginVars.cfm | 7/11/2002 7:21 PM | 2,291 |
| act_DownloadFile.cfm | 7/11/2002 7:21 PM | 178 |
| act_InitializeSession.cfm | 7/11/2002 7:21 PM | 2,085 |
| act_Logout.cfm | 7/11/2002 7:21 PM | 294 |
| act_RetrieveACHCreditsFileI . . . | 9/4/2002 9:44 AM | 1,534 |
| act_{—} | 9/4/2002 9:44 AM | 1,522 |
| RetrieveACHDebitsFileInf . . . | | |
| act_RetrieveMaintenanceFileI . . . | 9/4/2002 9:44 AM | 1,582 |
| act_RetrieveMonetaryFileInfo . . . | 9/4/2002 9:44 AM | 1,536 |
| dsp_BankRIMenu.cfm | 7/11/2002 7:21 PM | 562 |
| dsp_DownloadFiles.cfm | 9/4/2002 9:34 AM | 6,590 |
| dsp_Home.cfm | 7/11/2002 7:21 PM | 76 |
| dsp_ViewApplicationsReport . . . | 7/11/2002 7:21 PM | 2,934 |
| dsp_ViewCreditCardTransact . . . | 7/11/2002 7:21 PM | 1,152 |
| dsp_ViewReports.cfm | 8/15/2002 2:55 PM | 1,380 |
| fbx_Settings.cfm | 7/11/2002 7:21 PM | 357 |
| fbx_Switch.cfm | 8/15/2002 2:55 PM | 3,873 |
| qry_RetrieveCreditCardTrans . . . | 7/11/2002 7:21 PM | 1,742 |
| qry_{—} | 7/11/2002 7:21 PM | 1,440 |
| RetrieveNewApplications . . . | | |
| qry_RetrieveTodaysSummary . . . | 7/25/2002 1:09 PM | 1,673 |
| qry_RetrieveCampusPayTran . . . | 7/11/2002 7:21 PM | 1,443 |
| qry_RetrieveYTDSummary.cfm | 7/25/2002 1:09 PM | 1,416 |
| qry_RetrieveTodaysCampus . . . | 7/11/2002 7:21 PM | 1,802 |
| qry_RetrieveCampusPayTod . . . | 7/25/2002 1:09 PM | 1,858 |
| qry_RetrieveCampusPayYTD . . . | 7/25/2002 1:09 PM | 1,602 |
| qry_RetrieveOpsReport.cfm | 7/25/2002 1:09 PM | 3,350 |
| qry_RetrieveLateRISDPayme . . . | 8/15/2002 2:54 PM | 1,560 |
| dsp_ViewOpenedAccountsRe . . . | 7/25/2002 1:11 PM | 13,758 |
| dsp_ViewCampusPayTransa . . . | 7/25/2002 1:11 PM | 15,044 |
| act_SetSearchDate.cfm | 7/11/2002 7:21 PM | 587 |
| dsp_ViewOpsReport.cfm | 8/16/2002 2:41 PM | 10,956 |
| act_SetSchool.cfm | 7/11/2002 7:21 PM | 79 |
| dsp_ViewLateRISDPayments . . . | 8/15/2002 2:55 PM | 3,554 |
| act_RetrieveFileSummarys.cfm | 9/4/2002 9:14 AM | 2,235 |
| dsp_Login.cfm | 7/11/2002 7:21 PM | 2,746 |
| fbx_Settings.cfm | 7/11/2002 7:21 PM | 1,062 |
| fbx_Switch.cfm | 7/11/2002 7:21 PM | 1,401 |
| qry_Login.cfm | 7/11/2002 7:21 PM | 1,128 |
| act_CreditCardFundAccount . . . | 7/11/2002 3:03 PM | 4,941 |
| act_CreditCardOpenAccount . . . | 7/11/2002 3:03 PM | 6,671 |
| fbx_Settings.cfm | 9/9/2002 2:08 PM | 349 |
| fbx_Switch.cfm | 9/9/2002 2:08 PM | 2,713 |
| qry_RetrieveTransactionIDs . . . | 9/9/2002 2:08 PM | 915 |
| qry_UpdateWorksheetStatus . . . | 9/9/2002 2:08 PM | 1,045 |
| qry_RetrieveFunderByEmail . . . | 9/10/2002 9:25 AM | 804 |
| qry_{—} | 9/10/2002 9:25 AM | 818 |
| RetrieveStudentBySchool . . . | | |
| qry_RetrieveStudentFunderR . . . | 9/10/2002 9:25 AM | 835 |
| qry_UpdateStudent.cfm | 9/10/2002 9:25 AM | 4,203 |
| act_RISDStudentDatabaseRe . . . | 7/14/2002 12:08 PM | 1,801 |
| act_CancelPayment.cfm | 9/9/2002 2:08 PM | 2,600 |
| act_ImportAccounts.cfm | 9/10/2002 9:24 AM | 21,677 |
| act_VerifyAccounts.cfm | 9/9/2002 2:08 PM | 5,477 |
| act_ZIPCodeRefresh.cfm | 9/9/2002 2:08 PM | 4,088 |
| dsp_BatchOpenAcct.cfm | 9/9/2002 2:08 PM | 2,712 |
| dsp_Home.cfm | 9/9/2002 2:08 PM | 103 |
| dsp_SystemMenu.cfm | 9/9/2002 2:08 PM | 434 |
| dsp_ToolsMenu.cfm | 9/9/2002 2:08 PM | 879 |
| dsp_ViewPaymentWorksheet . . . | 9/9/2002 2:08 PM | 8,656 |
| dsp_ViewTools.cfm | 9/9/2002 2:08 PM | 848 |
| dsp_ViewZIPCodeMgr.cfm | 9/9/2002 2:08 PM | 482 |
| dsp_ViewZIPCodeRefresh.cfm | 9/9/2002 2:08 PM | 3,706 |
| dsp_ZIPCodeMenu.cfm | 9/9/2002 2:08 PM | 548 |
| fb3Logger.cfm | 9/9/2002 2:08 PM | 3,272 |
| url_ViewPaymentWorksheet . . . | 9/9/2002 2:08 PM | 115 |
| url_ViewZIPCodeRefresh.cfm | 9/9/2002 2:08 PM | 110 |
| fbx_Settings.cfm | 8/19/2002 4:39 PM | 357 |
| fbx_Switch.cfm | 8/19/2002 4:39 PM | 856 |
| qry_RetrieveWorksheetRepor . . . | 8/19/2002 4:39 PM | 3,336 |
| qry_RetrieveTuitionReport.cfm | 8/19/2002 4:39 PM | 2,837 |
| qry_RetrieveProgramReport . . . | 8/19/2002 4:39 PM | 2,879 |
| qry_{—} | 8/19/2002 4:39 PM | 2,979 |
| RetrieveDeferredTuitionR . . . | | |
| dsp_Home.cfm | 8/19/2002 4:39 PM | 606 |
| fbx_Settings.cfm | 8/19/2002 4:39 PM | 357 |
| fbx_Switch.cfm | 8/19/2002 4:39 PM | 3,011 |
| dsp_ViewReports.cfm | 8/19/2002 4:39 PM | 1,495 |
| dsp_ViewWorksheetReport.cfm | 8/19/2002 4:39 PM | 8,516 |
| dsp_PrintableWorksheet.cfm | 8/19/2002 4:39 PM | 18,063 |
| dsp_ViewTuitionReport.cfm | 8/19/2002 4:39 PM | 6,925 |
| dsp_ViewProgramReport.cfm | 8/19/2002 4:39 PM | 8,826 |
| dsp_ViewDeferredTuitionRep . . . | 8/19/2002 4:39 PM | 7,249 |
| dsp_SearchHeader.cfm | 8/19/2002 4:39 PM | 4,593 |
| dsp_UniversityMenu.cfm | 8/19/2002 4:39 PM | 1,087 |
| act_SetSearchDate.cfm | 8/19/2002 4:39 PM | 2,073 |
| url_Home.cfm | 7/11/2002 7:21 PM | 88 |
| test.cfm | 6/19/2002 12:12 PM | 91 |
| act_Logout.cfm | 7/11/2002 7:21 PM | 294 |
| act_SetSearchDate.cfm | 7/11/2002 7:21 PM | 587 |
| fbx_Layouts.cfm | 6/20/2002 3:26 PM | 2,131 |
| fbx_Settings.cfm | 7/19/2002 11:37 AM | 13,873 |
| fbx_Switch.cfm | 9/23/2002 2:30 PM | 3,931 |
| index.cfm | 7/11/2002 4:06 PM | 818 |
| url_SchoolLanding.cfm | 6/19/2002 3:27 PM | 342 |
| wiz_JWUTuitionWorksheet.cfm | 7/11/2002 5:34 PM | 5,771 |
| wiz_OpenAccount.cfm | 7/12/2002 8:56 AM | 5,439 |
| Application.cfm | 6/13/2001 3:52 PM | 5,356 |
| advancedlogin.cfm | 6/13/2001 3:52 PM | 4,635 |
| cfadmin.css | 6/13/2001 3:45 PM | 826 |
| cfadmin_ns.css | 6/13/2001 3:45 PM | 818 |
| cfadmin_unix.css | 6/13/2001 3:45 PM | 847 |
| cfadminleft.css | 6/13/2001 3:45 PM | 600 |
| cfadminleft_ns.css | 6/13/2001 3:45 PM | 557 |
| cfadminleft_unix.css | 6/13/2001 3:45 PM | 461 |
| index.cfm | 6/13/2001 3:52 PM | 206 |
| indexcollection.cfm | 6/13/2001 3:52 PM | 4,874 |
| k2verity.cfm | 6/13/2001 3:52 PM | 6,388 |
| verity.cfm | 6/13/2001 3:52 PM | 10,865 |
| application.cfm | 6/13/2001 3:52 PM | 294 |
| displaycfdssettings.cfm | 6/13/2001 3:52 PM | 4,888 |
| db2.cfm | 6/13/2001 3:52 PM | 9,254 |
| db2_unix.cfm | 6/13/2001 3:52 PM | 8,334 |
| dbase.cfm | 6/13/2001 3:52 PM | 13,899 |
| dbase_unix.cfm | 6/13/2001 3:52 PM | 11,746 |
| dsnsecurity.cfm | 6/13/2001 3:52 PM | 2,130 |
| excel.cfm | 6/13/2001 3:52 PM | 13,300 |
| filemaker.cfm | 6/13/2001 3:52 PM | 13,772 |
| foxpro.cfm | 6/13/2001 3:52 PM | 13,693 |
| informix73.cfm | 6/13/2001 3:52 PM | 16,017 |
| informix9_unix.cfm | 6/13/2001 3:52 PM | 8,646 |
| informix9c23.cfm | 6/13/2001 3:52 PM | 14,132 |
| informix_unix.cfm | 6/13/2001 3:52 PM | 11,011 |
| jetoledb.cfm | 6/13/2001 3:52 PM | 11,335 |
| merant_db2udb_win32.cfm | 6/13/2001 3:52 PM | 8,495 |
| merant_dbase_win32.cfm | 6/13/2001 3:52 PM | 17,008 |
| merant_informix9_win32.cfm | 6/13/2001 3:52 PM | 10,319 |
| merant_informix_win32.cfm | 6/13/2001 3:52 PM | 13,472 |
| merant_oracle8_win32.cfm | 6/13/2001 3:52 PM | 10,209 |
| merant_paradox_win32.cfm | 6/13/2001 3:52 PM | 13,594 |
| merant_progress_win32.cfm | 6/13/2001 3:52 PM | 7,653 |
| merant_sqlbase_win32.cfm | 6/13/2001 3:52 PM | 12,822 |
| merant_sybase_win32.cfm | 6/13/2001 3:52 PM | 12,076 |
| merant_text_win32.cfm | 6/13/2001 3:52 PM | 15,216 |
| merant_xls_win32.cfm | 6/13/2001 3:52 PM | 14,291 |
| msaccess.cfm | 6/13/2001 3:52 PM | 18,082 |
| mssql_unix.cfm | 6/13/2001 3:52 PM | 9,202 |
| mssqlserver.cfm | 6/13/2001 3:52 PM | 14,811 |
| myodbc_mysql.cfm | 6/13/2001 3:52 PM | 8,374 |
| mysql.cfm | 6/13/2001 3:52 PM | 8,051 |
| oledb.cfm | 6/13/2001 3:52 PM | 10,593 |
| openingres2_unix.cfm | 6/13/2001 3:52 PM | 12,467 |
| openingres_unix.cfm | 6/13/2001 3:52 PM | 12,465 |
| oracle73.cfm | 6/13/2001 3:52 PM | 9,831 |
| oracle80.cfm | 6/13/2001 3:52 PM | 9,821 |
| oracle8_unix.cfm | 6/13/2001 3:52 PM | 8,592 |
| oracle_microsoft.cfm | 6/13/2001 3:52 PM | 13,669 |
| oracle_unix.cfm | 6/13/2001 3:52 PM | 9,128 |
| oracle_visigenic.cfm | 6/13/2001 3:52 PM | 16,232 |
| paradox.cfm | 6/13/2001 3:52 PM | 16,725 |
| postgresql.cfm | 6/13/2001 3:52 PM | 8,783 |
| registered_native_drivers.cfm | 6/13/2001 3:52 PM | 1,732 |
| registered_oledb_drivers.cfm | 6/13/2001 3:52 PM | 924 |
| registereddrivers.cfm | 6/13/2001 3:52 PM | 5,488 |
| sqloledb.cfm | 6/13/2001 3:52 PM | 11,255 |
| sybase11.cfm | 6/13/2001 3:52 PM | 11,823 |
| sybase11_linux.cfm | 6/13/2001 3:52 PM | 10,961 |
| sybase_unix.cfm | 6/13/2001 3:52 PM | 10,346 |
| text.cfm | 6/13/2001 3:52 PM | 11,951 |
| text_unix.cfm | 6/13/2001 3:52 PM | 12,586 |
| visualfoxpro.cfm | 6/13/2001 3:52 PM | 15,515 |
| edit_native_dsinfo.cfm | 6/13/2001 3:52 PM | 17,847 |
| edit_oledb_dsinfo.cfm | 6/13/2001 3:52 PM | 17,839 |
| editcfdsinfoonly.cfm | 6/13/2001 3:52 PM | 1,778 |
| editdsinfo.cfm | 6/13/2001 3:52 PM | 19,496 |
| error.cfm | 6/13/2001 3:52 PM | 1,999 |
| get_native_driver_info.cfm | 6/13/2001 3:52 PM | 7,410 |
| get_oledb_driver_info.cfm | 6/13/2001 3:52 PM | 6,989 |
| getcfdssettings.cfm | 6/13/2001 3:52 PM | 6,557 |
| getdriverinfo.cfm | 6/13/2001 3:52 PM | 7,452 |
| index.cfm | 6/13/2001 3:52 PM | 6,341 |
| native_index.cfm | 6/13/2001 3:52 PM | 6,170 |
| oledb_index.cfm | 6/13/2001 3:52 PM | 5,308 |
| update_native_cf_dsinfo.cfm | 6/13/2001 3:52 PM | 6,489 |
| update_oledb_cf_dsinfo.cfm | 6/13/2001 3:52 PM | 6,489 |
| updatecf_dsinfo.cfm | 6/13/2001 3:52 PM | 7,564 |
| updatecfdsinfoonly.cfm | 6/13/2001 3:52 PM | 541 |
| verify.cfm | 6/13/2001 3:52 PM | 5,283 |
| verifyds.cfm | 6/13/2001 3:52 PM | 1,189 |
| index.cfm | 6/13/2001 3:52 PM | 207 |
| iplist.cfm | 6/13/2001 3:52 PM | 4,909 |
| logging.cfm | 6/13/2001 3:52 PM | 207 |
| options.cfm | 6/13/2001 3:52 PM | 6,245 |
| default.htm | 6/13/2001 3:45 PM | 54 |
| Application.cfm | 6/13/2001 3:52 PM | 253 |
| _nttestinstall.cfm | 6/13/2001 3:52 PM | 2,485 |
| _unixtestinstall.cfm | 6/13/2001 3:52 PM | 1,257 |
| allaire_ie.css | 6/13/2001 3:45 PM | 2,890 |
| allaire_ns.css | 6/13/2001 3:45 PM | 3,763 |
| apicgi.htm | 6/13/2001 3:45 PM | 4,371 |
| ArcWizBG.gif | 6/13/2001 3:45 PM | 9,712 |
| alert.gif | 6/13/2001 3:45 PM | 140 |
| allaire.gif | 6/13/2001 3:45 PM | 1,149 |
| apply_a.gif | 6/13/2001 3:45 PM | 269 |
| archive.gif | 6/13/2001 3:45 PM | 384 |
| archivebg.gif | 6/13/2001 3:45 PM | 11,895 |
| archivebg2.gif | 6/13/2001 3:45 PM | 11,575 |
| archivelefftbg.gif | 6/13/2001 3:45 PM | 2,779 |
| back.gif | 6/13/2001 3:45 PM | 387 |
| bang.gif | 6/13/2001 3:45 PM | 1,360 |
| bluecurve.gif | 6/13/2001 3:45 PM | 2,799 |
| build.gif | 6/13/2001 3:45 PM | 384 |
| build_button.gif | 6/13/2001 3:45 PM | 384 |
| cancel_a.gif | 6/13/2001 3:45 PM | 309 |
| cf50brand.jpg | 6/13/2001 3:45 PM | 21,749 |
| cf5_small.gif | 6/13/2001 3:45 PM | 4,155 |
| clear.gif | 6/13/2001 3:45 PM | 43 |
| coldfusion50.gif | 6/13/2001 3:45 PM | 8,865 |
| coldfusion50admin.gif | 6/13/2001 3:45 PM | 2,157 |
| coldfusion50small.gif | 6/13/2001 3:45 PM | 3,052 |
| corp_1_color_stacked_2.gif | 6/13/2001 3:45 PM | 2,652 |
| delete_button.gif | 6/13/2001 3:45 PM | 377 |
| deletered.gif | 6/13/2001 3:45 PM | 377 |
| divider.gif | 6/13/2001 3:45 PM | 37 |
| doit.gif | 6/13/2001 3:45 PM | 2,079 |
| download.gif | 6/13/2001 3:45 PM | 370 |
| edit.gif | 6/13/2001 3:45 PM | 272 |
| edit_button.gif | 6/13/2001 3:45 PM | 272 |
| evaluation.gif | 6/13/2001 3:45 PM | 1,051 |
| expired.gif | 6/13/2001 3:45 PM | 1,325 |
| export.gif | 6/13/2001 3:45 PM | 598 |
| filterhelp.gif | 6/13/2001 3:45 PM | 255 |
| footerbg2000.gif | 6/13/2001 3:45 PM | 23,523 |
| greendot.gif | 6/13/2001 3:45 PM | 282 |
| headerbg.jpg | 6/13/2001 3:45 PM | 10,738 |
| headerbg2000.gif | 6/13/2001 3:45 PM | 20,863 |
| headerbg2000.jpg | 6/13/2001 3:45 PM | 19,309 |
| headerbg2000x2000.gif | 6/13/2001 3:45 PM | 15,900 |
| headerstub.jpg | 6/13/2001 3:45 PM | 1,804 |
| help.gif | 6/13/2001 3:45 PM | 189 |
| home.gif | 6/13/2001 3:45 PM | 178 |
| homebandbg2000.gif | 6/13/2001 3:45 PM | 10,812 |
| homeimage.jpg | 6/13/2001 3:45 PM | 20,012 |
| leftbgblue.gif | 6/13/2001 3:45 PM | 12,487 |
| leftbgblue1.gif | 6/13/2001 3:45 PM | 12,505 |
| lg.gif | 6/13/2001 3:45 PM | 817 |
| local_resources.gif | 6/13/2001 3:45 PM | 549 |
| loginbg.gif | 6/13/2001 3:45 PM | 1,009 |
| loginbg3.gif | 6/13/2001 3:45 PM | 1,008 |
| loginbg4.gif | 6/13/2001 3:45 PM | 1,007 |
| logout.gif | 6/13/2001 3:45 PM | 171 |
| mainbg.gif | 6/13/2001 3:45 PM | 487 |
| mmcoldfusion5.gif | 6/13/2001 3:45 PM | 1,899 |
| ok.gif | 6/13/2001 3:45 PM | 350 |
| online_resources.gif | 6/13/2001 3:45 PM | 603 |
| rg.gif | 6/13/2001 3:45 PM | 817 |
| run_button.gif | 6/13/2001 3:45 PM | 272 |
| schedule.gif | 6/13/2001 3:45 PM | 399 |
| spacer.gif | 6/13/2001 3:45 PM | 43 |
| tabsbg.gif | 6/13/2001 3:45 PM | 346 |
| technical_support.gif | 6/13/2001 3:45 PM | 606 |
| toolbarbg.gif | 6/13/2001 3:45 PM | 507 |
| update.gif | 6/13/2001 3:45 PM | 251 |
| view.gif | 6/13/2001 3:45 PM | 622 |
| view_button.gif | 6/13/2001 3:45 PM | 622 |
| index.htm | 6/13/2001 3:45 PM | 7,707 |
| local.htm | 6/13/2001 3:45 PM | 3,128 |
| mmcoldfusion5.gif | 6/13/2001 3:45 PM | 1,908 |
| new.htm | 6/13/2001 3:45 PM | 15,425 |
| odbc.htm | 6/13/2001 3:45 PM | 3,135 |
| releasenotes.htm | 6/13/2001 3:45 PM | 40,864 |
| sorry.htm | 6/13/2001 3:45 PM | 1,728 |
| testinstall.cfm | 6/13/2001 3:52 PM | 4,000 |
| _cfxedit_cpp.cfm | 6/13/2001 3:52 PM | 8,433 |
| _cfxedit_delete.cfm | 6/13/2001 3:52 PM | 474 |
| _cfxedit_java.cfm | 6/13/2001 3:52 PM | 6,146 |
| appletedit.cfm | 6/13/2001 3:52 PM | 10,300 |
| applets.cfm | 6/13/2001 3:52 PM | 4,823 |
| cfx_tags.cfm | 6/13/2001 3:52 PM | 5,536 |
| cfxedit.cfm | 6/13/2001 3:52 PM | 573 |
| corba.cfm | 6/13/2001 3:52 PM | 4,479 |
| corbaedit.cfm | 6/13/2001 3:52 PM | 5,002 |
| customtagpaths.cfm | 6/13/2001 3:52 PM | 5,177 |
| index.cfm | 6/13/2001 3:52 PM | 208 |
| java.cfm | 6/13/2001 3:52 PM | 10,197 |
| index.cfm | 6/13/2001 3:52 PM | 3,760 |
| serverbrowser.cfm | 6/13/2001 3:52 PM | 4,134 |
| footer.cfm | 6/13/2001 3:52 PM | 828 |
| footer.cfm | 6/13/2001 3:52 PM | 346 |
| header.cfm | 6/13/2001 3:52 PM | 1,052 |
| header.cfm | 6/13/2001 3:52 PM | 2,462 |
| headerbuttons.cfm | 6/13/2001 3:52 PM | 453 |
| _blank.htm | 6/13/2001 3:45 PM | 222 |
| _blank.js | 6/13/2001 3:45 PM | 307 |
| about_advanced_administrati . . . | 6/13/2001 3:45 PM | 5,689 |
| about_{—} | 6/13/2001 3:45 PM | 5,217 |
| coldfusion_data_sourc . . . | | |
| about_database_drivers.htm | 6/13/2001 3:45 PM | 8,565 |
| about_debugging_settings.htm | 6/13/2001 3:45 PM | 5,135 |
| about_{—} | 6/13/2001 3:45 PM | 4,760 |
| java_settings_for_cold . . . | | |
| about_{—} | 6/13/2001 3:45 PM | 4,891 |
| logical_aliases_for_ph . . . | | |
| about_policies.htm | 6/13/2001 3:45 PM | 5,321 |
| about_protecting_resources . . . | 6/13/2001 3:45 PM | 5,072 |
| about_releasing_database_c . . . | 6/13/2001 3:45 PM | 5,203 |
| about_remote_development_. . . | 6/13/2001 3:45 PM | 5,104 |
| about_runtime_security.htm | 6/13/2001 3:45 PM | 5,203 |
| about_security_contexts.htm | 6/13/2001 3:45 PM | 6,621 |
| about_security_sandboxes.htm | 6/13/2001 3:45 PM | 6,109 |
| about_the_advanced_securit . . . | 6/13/2001 3:45 PM | 6,409 |
| about_{—} | 6/13/2001 3:45 PM | 8,649 |
| the_coldfusion_probe_. . . | | |
| about_{—} | 6/13/2001 3:45 PM | 6,425 |
| the_data_sources_pag . . . | | |
| about_the_security_map.htm | 6/13/2001 3:45 PM | 4,183 |
| about_the_security_options . . . | 6/13/2001 3:45 PM | 5,727 |
| about_user_directories.htm | 6/13/2001 3:45 PM | 7,436 |
| about_{—} | 6/13/2001 3:45 PM | 5,847 |
| verifying_coldfusion_d . . . | | |
| add_policies.htm | 6/13/2001 3:45 PM | 5,304 |
| add_rules_example.htm | 6/13/2001 3:45 PM | 8,438 |
| addeditcftag.htm | 6/13/2001 3:45 PM | 14,688 |
| addeditjavaapplet.htm | 6/13/2001 3:45 PM | 18,080 |
| addedittask.htm | 6/13/2001 3:45 PM | 20,128 |
| adding_{—} | 6/13/2001 3:45 PM | 7,588 |
| and_defining_variabl . . . | | |
| adding_lb_device.htm | 6/13/2001 3:45 PM | 6,935 |
| adding_probes.htm | 6/13/2001 3:45 PM | 7,116 |
| advanced_rds_security.htm | 6/13/2001 3:45 PM | 5,606 |
| advanced_security_levels.htm | 6/13/2001 3:45 PM | 7,394 |
| analyze_{—} | 6/13/2001 3:45 PM | 4,864 |
| server_activity_in_lo . . . | | |
| anatomy.gif | 6/13/2001 3:45 PM | 24,650 |
| anatomy_{—} | 6/13/2001 3:45 PM | 6,423 |
| of_the_coldfusion_. . . | | |
| applets_tab.htm | 6/13/2001 3:45 PM | 7,176 |
| appserset.htm | 6/13/2001 3:45 PM | 16,567 |
| archive_build.htm | 6/13/2001 3:45 PM | 7,435 |
| archive_information_tab.htm | 6/13/2001 3:45 PM | 7,018 |
| archive_security_overview.htm | 6/13/2001 3:45 PM | 9,308 |
| archive_security_page.htm | 6/13/2001 3:45 PM | 10,926 |
| archive_settings_page.htm | 6/13/2001 3:45 PM | 10,466 |
| archive_summary_tab.htm | 6/13/2001 3:45 PM | 5,824 |
| archive_to_do_list_tab.htm | 6/13/2001 3:45 PM | 6,820 |
| archive_variables_tab.htm | 6/13/2001 3:45 PM | 7,733 |
| archivelogbut.gif | 6/13/2001 3:45 PM | 1,024 |
| archivesecuritypage.gif | 6/13/2001 3:45 PM | 24,047 |
| assign_rules_to_policies.htm | 6/13/2001 3:45 PM | 6,499 |
| assign_users_to_policies.htm | 6/13/2001 3:45 PM | 6,041 |
| automation.htm | 6/13/2001 3:45 PM | 5,499 |
| automationset.gif | 6/13/2001 3:45 PM | 18,239 |
| backarrow.gif | 6/13/2001 3:45 PM | 1,004 |
| backup_log_file.htm | 6/13/2001 3:45 PM | 4,581 |
| browser-based_working_envi . . . | 6/13/2001 3:45 PM | 4,418 |
| bsscdhtm.js | 6/13/2001 3:45 PM | 69,602 |
| bsscftp.ds | 6/13/2001 3:45 PM | 36,034 |
| bsscnav1.gif | 6/13/2001 3:45 PM | 272 |
| bsscnav2.gif | 6/13/2001 3:45 PM | 263 |
| bsscnav3.gif | 6/13/2001 3:45 PM | 224 |
| bsscnav4.gif | 6/13/2001 3:45 PM | 151 |
| bsscnav5.gif | 6/13/2001 3:45 PM | 152 |
| bsscnav6.gif | 6/13/2001 3:45 PM | 246 |
| bsscnav7.gif | 6/13/2001 3:45 PM | 911 |
| bsscnav8.gif | 6/13/2001 3:45 PM | 911 |
| bsscnbar.js | 6/13/2001 3:45 PM | 9,552 |
| bssctab0.gif | 6/13/2001 3:45 PM | 1,121 |
| bssctab1.gif | 6/13/2001 3:45 PM | 509 |
| bssctab2.gif | 6/13/2001 3:45 PM | 669 |
| bssctab3.gif | 6/13/2001 3:45 PM | 429 |
| bssctab4.gif | 6/13/2001 3:45 PM | 553 |
| bssctab5.gif | 6/13/2001 3:45 PM | 544 |
| bssctab6.gif | 6/13/2001 3:45 PM | 607 |
| bssctoc1.gif | 6/13/2001 3:45 PM | 945 |
| bssctoc2.gif | 6/13/2001 3:45 PM | 959 |
| bssctoc3.gif | 6/13/2001 3:45 PM | 155 |
| bssctoc4.gif | 6/13/2001 3:45 PM | 947 |
| cachepopreport.gif | 6/13/2001 3:45 PM | 10,904 |
| cachepops.htm | 6/13/2001 3:45 PM | 7,819 |
| certificate_formats.htm | 6/13/2001 3:45 PM | 5,318 |
| certificates.htm | 6/13/2001 3:45 PM | 7,190 |
| certificatetab.gif | 6/13/2001 3:45 PM | 6,095 |
| cfadd_logs.htm | 6/13/2001 3:45 PM | 6,063 |
| cfaddeditcftag.htm | 6/13/2001 3:45 PM | 6,078 |
| cfaddeditcorbaext.htm | 6/13/2001 3:45 PM | 6,090 |
| cfaddeditjavaapplet.htm | 6/13/2001 3:45 PM | 6,098 |
| cfaddeditjavatag.htm | 6/13/2001 3:45 PM | 6,086 |
| cfaddedittask.htm | 6/13/2001 3:45 PM | 6,074 |
| cfadminhelp.ftp | 6/13/2001 3:45 PM | 8,154 |
| cfadminhelp.hhc | 6/13/2001 3:45 PM | 50,492 |
| cfadminhelp.hhc.zip | 6/13/2001 3:45 PM | 5,455 |
| cfadminhelp.hhk | 6/13/2001 3:45 PM | 246,325 |
| cfadminhelp.hhk.zip | 6/13/2001 3:45 PM | 22,409 |
| cfadminhelp.hhs | 6/13/2001 3:45 PM | 116,406 |
| cfadminhelp.hhs.zip | 6/13/2001 3:45 PM | 34,880 |
| cfadminhelp.htm | 6/13/2001 3:45 PM | 6,044 |
| cfalarm.htm | 6/13/2001 3:45 PM | 6,112 |
| cfadminhelp_csh.htm | 6/13/2001 3:45 PM | 5,340 |
| cfapplets.htm | 6/13/2001 3:45 PM | 6,074 |
| cfappserset.htm | 6/13/2001 3:45 PM | 6,065 |
| cfarchiveinfo.htm | 6/13/2001 3:45 PM | 6,117 |
| cfarchivesettings.htm | 6/13/2001 3:45 PM | 6,114 |
| cfarchvariables.htm | 6/13/2001 3:45 PM | 6,114 |
| cfasecurity.htm | 6/13/2001 3:45 PM | 6,119 |
| cfautoset.htm | 6/13/2001 3:45 PM | 6,069 |
| cfcertficates.htm | 6/13/2001 3:45 PM | 6,078 |
| cfcftags.htm | 6/13/2001 3:45 PM | 6,054 |
| cfcfx.htm | 6/13/2001 3:45 PM | 6,078 |
| cfconadmail.htm | 6/13/2001 3:45 PM | 6,065 |
| cfconfadsec.htm | 6/13/2001 3:45 PM | 6,065 |
| cfconfatsrc.htm | 6/13/2001 3:45 PM | 6,069 |
| cfconfodbcsrc.htm | 6/13/2001 3:45 PM | 6,073 |
| cfconfolesrc.htm | 6/13/2001 3:45 PM | 6,069 |
| cfconmerdbasefox.htm | 6/13/2001 3:45 PM | 6,085 |
| cfconmertxtdb.htm | 6/13/2001 3:45 PM | 6,073 |
| cfconsum.htm | 6/13/2001 3:45 PM | 6,053 |
| cfconuserdir.htm | 6/13/2001 3:45 PM | 6,069 |
| cfcorbaextensions.htm | 6/13/2001 3:45 PM | 6,062 |
| cfcreatearchivedefinition.htm | 6/13/2001 3:45 PM | 6,113 |
| cfcrevercllx.htm | 6/13/2001 3:45 PM | 6,069 |
| cfcrlogmap.htm | 6/13/2001 3:45 PM | 6,065 |
| cfcustomprobe.htm | 6/13/2001 3:45 PM | 6,122 |
| cfcustomtag.htm | 6/13/2001 3:45 PM | 6,066 |
| cfdebgopt.htm | 6/13/2001 3:45 PM | 6,057 |
| cfdecryptarchive.htm | 6/13/2001 3:45 PM | 6,086 |
| cfdefaultprobe.htm | 6/13/2001 3:45 PM | 6,125 |
| cfdirmap.htm | 6/13/2001 3:45 PM | 6,117 |
| cfdoc.htm | 6/13/2001 3:45 PM | 6,041 |
| cfencryptarchive.htm | 6/13/2001 3:46 PM | 6,095 |
| cfexample.htm | 6/13/2001 3:46 PM | 6,057 |
| cfexport.htm | 6/13/2001 3:46 PM | 6,151 |
| cffiledir.htm | 6/13/2001 3:46 PM | 6,113 |
| cffilter.htm | 6/13/2001 3:46 PM | 6,054 |
| cffilter_tab.htm | 6/13/2001 3:46 PM | 6,075 |
| cffilterset.htm | 6/13/2001 3:46 PM | 6,143 |
| cfgenarchive.htm | 6/13/2001 3:46 PM | 6,102 |
| cfhome.htm | 6/13/2001 3:46 PM | 6,063 |
| cfidcfinf.htm | 6/13/2001 3:46 PM | 6,057 |
| cfimportcert.htm | 6/13/2001 3:46 PM | 6,167 |
| cfjavaapplet.htm | 6/13/2001 3:46 PM | 6,070 |
| cfjvmandjava.htm | 6/13/2001 3:46 PM | 6,070 |
| cfkb.htm | 6/13/2001 3:46 PM | 6,037 |
| cflbdevice.htm | 6/13/2001 3:46 PM | 6,093 |
| cflist.htm | 6/13/2001 3:46 PM | 6,117 |
| cflogfiles.htm | 6/13/2001 3:46 PM | 6,062 |
| cflogset.htm | 6/13/2001 3:46 PM | 6,074 |
| cflogviewer.htm | 6/13/2001 3:46 PM | 6,066 |
| cfmgeclivar#clientvartab.htm | 6/13/2001 3:46 PM | 6,117 |
| cfmgeclivar.htm | 6/13/2001 3:46 PM | 6,065 |
| cfmgeclivarclientvartab.htm | 6/13/2001 3:46 PM | 6,089 |
| cfmnememvar.htm | 6/13/2001 3:46 PM | 6,065 |
| cfmnglckvar.htm | 6/13/2001 3:46 PM | 6,065 |
| cfmngmemvar.htm | 6/13/2001 3:46 PM | 6,065 |
| cfmodifyarchivedefinition.htm | 6/13/2001 3:46 PM | 6,126 |
| cfmodifyvariable.htm | 6/13/2001 3:46 PM | 6,149 |
| cfnewvariable.htm | 6/13/2001 3:46 PM | 6,146 |
| cfnotes.htm | 6/13/2001 3:46 PM | 6,049 |
| cfprobes.htm | 6/13/2001 3:46 PM | 6,154 |
| cfprobesetup.htm | 6/13/2001 3:46 PM | 6,087 |
| cfregsecon.htm | 6/13/2001 3:46 PM | 6,065 |
| cfrestore.htm | 6/13/2001 3:46 PM | 6,110 |
| cfrstdebug.htm | 6/13/2001 3:46 PM | 6,065 |
| cfsched_build.htm | 6/13/2001 3:46 PM | 6,081 |
| cfschedtask.htm | 6/13/2001 3:46 PM | 6,066 |
| cfsecmap.htm | 6/13/2001 3:46 PM | 6,053 |
| cfsecres.htm | 6/13/2001 3:46 PM | 6,053 |
| cfsecsand.htm | 6/13/2001 3:46 PM | 6,057 |
| cfselcfset.htm | 6/13/2001 3:46 PM | 6,061 |
| cfsetcacpref.htm | 6/13/2001 3:46 PM | 6,069 |
| cfsetcfpsswrd.htm | 6/13/2001 3:46 PM | 6,073 |
| cfsetcfstdpass.htm | 6/13/2001 3:46 PM | 6,077 |
| cfsetcftag.htm | 6/13/2001 3:46 PM | 6,061 |
| cfsetchange.htm | 6/13/2001 3:46 PM | 6,066 |
| cfsetlogopt.htm | 6/13/2001 3:46 PM | 6,065 |
| cfsetsummary.htm | 6/13/2001 3:46 PM | 6,070 |
| cfsettings.htm | 6/13/2001 3:46 PM | 6,078 |
| cfsignarchive.htm | 6/13/2001 3:46 PM | 6,074 |
| cfsources.htm | 6/13/2001 3:46 PM | 6,093 |
| cfstats_tab.htm | 6/13/2001 3:46 PM | 6,091 |
| cfstatssum.htm | 6/13/2001 3:46 PM | 6,062 |
| cfstyles.css | 6/13/2001 3:46 PM | 5,889 |
| cfstyles_ns.css | 6/13/2001 3:46 PM | 3,611 |
| cfsummary.htm | 6/13/2001 3:46 PM | 6,106 |
| cftags.htm | 6/13/2001 3:46 PM | 7,148 |
| cftasks.htm | 6/13/2001 3:46 PM | 6,105 |
| cfverifyarchive.htm | 6/13/2001 3:46 PM | 6,082 |
| cfverity.htm | 6/13/2001 3:46 PM | 6,117 |
| cfverk2.htm | 6/13/2001 3:46 PM | 6,049 |
| cfwebsiteconfig.htm | 6/13/2001 3:46 PM | 6,089 |
| cfx_tags_(c++_and_java).htm | 6/13/2001 3:46 PM | 5,074 |
| cfx_tags_tab.htm | 6/13/2001 3:46 PM | 7,223 |
| cfxpage.gif | 6/13/2001 3:46 PM | 5,351 |
| change_coldfusion_user_acc . . . | 6/13/2001 3:46 PM | 7,159 |
| clivar.gif | 6/13/2001 3:46 PM | 4,304 |
| changing_defaultlog_dir.htm | 6/13/2001 3:46 PM | 4,628 |
| chgadpwrd.htm | 6/13/2001 3:46 PM | 4,965 |
| client_variable_planning.htm | 6/13/2001 3:46 PM | 11,899 |
| coldfusion_processes_on_hp . . . | 6/13/2001 3:46 PM | 7,615 |
| coldfusion_processes_on_lin . . . | 6/13/2001 3:46 PM | 10,835 |
| coldfusion_{—} | 6/13/2001 3:46 PM | 12,577 |
| processes_on_sol . . . | | |
| coldfusion_{—} | 6/13/2001 3:46 PM | 13,918 |
| services_on_wind . . . | | |
| coldfusionprobe.gif | 6/13/2001 3:46 PM | 16,559 |
| conaccdb.htm | 6/13/2001 3:46 PM | 15,915 |
| conadmail.htm | 6/13/2001 3:46 PM | 16,626 |
| condb2db.htm | 6/13/2001 3:46 PM | 9,707 |
| condbasedb.htm | 6/13/2001 3:46 PM | 13,352 |
| conexceldb.htm | 6/13/2001 3:46 PM | 12,266 |
| confadsec.htm | 6/13/2001 3:46 PM | 43,880 |
| configure_the_performance_. . . | 6/13/2001 3:46 PM | 5,788 |
| confnatsrc.htm | 6/13/2001 3:46 PM | 10,052 |
| confodbcsrc.htm | 6/13/2001 3:46 PM | 12,126 |
| confolesrc.htm | 6/13/2001 3:46 PM | 9,643 |
| confoxprodb.htm | 6/13/2001 3:46 PM | 14,787 |
| coninf73db.htm | 6/13/2001 3:46 PM | 17,578 |
| conjetoledb.htm | 6/13/2001 3:46 PM | 11,943 |
| conmerdbasefox.htm | 6/13/2001 3:46 PM | 13,215 |
| conmerinfrmxdb.htm | 6/13/2001 3:46 PM | 13,582 |
| conmeroracle.htm | 6/13/2001 3:46 PM | 10,014 |
| conmertxtdb.htm | 6/13/2001 3:46 PM | 14,993 |
| connect_{—} | 6/13/2001 3:46 PM | 7,575 |
| to_a_remote_file-ba . . . | | |
| connect_{—} | 6/13/2001 3:46 PM | 9,667 |
| to_merant_excel_w . . . | | |
| connect_{—} | 6/13/2001 3:46 PM | 12,733 |
| to_merant_informix_. . . | | |
| connect_to_merant_paradox . . . | 6/13/2001 3:46 PM | 10,598 |
| connect_{—} | 6/13/2001 3:46 PM | 6,543 |
| to_network_data_so . . . | | |
| connect_to_merant_progress . . . | 6/13/2001 3:46 PM | 8,556 |
| connect_to_merant_sqlbase_. . . | 6/13/2001 3:46 PM | 10,678 |
| connect_{—} | 6/13/2001 3:46 PM | 14,751 |
| to_sybase_ase_driv . . . | | |
| conorc73.htm | 6/13/2001 3:46 PM | 10,419 |
| conorc80.htm | 6/13/2001 3:46 PM | 10,077 |
| conotherdb.htm | 6/13/2001 3:46 PM | 10,677 |
| consqldb.htm | 6/13/2001 3:46 PM | 24,748 |
| consqloledb.htm | 6/13/2001 3:46 PM | 11,543 |
| consum.htm | 6/13/2001 3:46 PM | 6,449 |
| consybdb.htm | 6/13/2001 3:46 PM | 12,121 |
| contextdb.htm | 6/13/2001 3:46 PM | 10,835 |
| contextpic.gif | 6/13/2001 3:46 PM | 10,153 |
| conuserdir.htm | 6/13/2001 3:46 PM | 26,347 |
| conxstringopt.htm | 6/13/2001 3:46 PM | 9,795 |
| corbaext.htm | 6/13/2001 3:46 PM | 7,710 |
| create_an_advanced_securit . . . | 6/13/2001 3:46 PM | 7,452 |
| createmapping.gif | 6/13/2001 3:46 PM | 3,121 |
| creating_site_archive.htm | 6/13/2001 3:46 PM | 10,454 |
| crelogmap.htm | 6/13/2001 3:46 PM | 6,469 |
| crevercllx.htm | 6/13/2001 3:46 PM | 7,332 |
| customtag.htm | 6/13/2001 3:46 PM | 6,458 |
| customtagpath.gif | 6/13/2001 3:46 PM | 5,059 |
| daily.htm | 6/13/2001 3:46 PM | 4,826 |
| data_sources_tab.htm | 6/13/2001 3:46 PM | 7,304 |
| databasereport.gif | 6/13/2001 3:46 PM | 11,263 |
| datasourcemain.gif | 6/13/2001 3:46 PM | 11,552 |
| dboperations.htm | 6/13/2001 3:46 PM | 7,506 |
| debgopt.htm | 6/13/2001 3:46 PM | 16,723 |
| decryptarchive.htm | 6/13/2001 3:46 PM | 9,894 |
| ehlpdht1.js | 6/13/2001 3:46 PM | 43,881 |
| define_a_security_context.htm | 6/13/2001 3:46 PM | 5,546 |
| define_a_user_directory.htm | 6/13/2001 3:46 PM | 6,955 |
| delete_archive_definition.htm | 6/13/2001 3:46 PM | 6,405 |
| delete_{—} | 6/13/2001 3:46 PM | 4,770 |
| certificate_from_coldf . . . | | |
| deletelogbut.gif | 6/13/2001 3:46 PM | 1,001 |
| deleting_probe.htm | 6/13/2001 3:46 PM | 5,345 |
| digital_signature.htm | 6/13/2001 3:46 PM | 3,399 |
| directory_mappings_tab.htm | 6/13/2001 3:46 PM | 7,484 |
| documentation.htm | 6/13/2001 3:46 PM | 5,947 |
| download_log_file.htm | 6/13/2001 3:46 PM | 4,875 |
| downloadbut.gif | 6/13/2001 3:46 PM | 1,007 |
| edit_probe_configuration.htm | 6/13/2001 3:46 PM | 6,727 |
| ehlpdht2.js | 6/13/2001 3:46 PM | 67,667 |
| ehlpdhtm.js | 6/13/2001 3:46 PM | 111,320 |
| enable_advanced_security.htm | 6/13/2001 3:46 PM | 4,803 |
| enable_coldfusion_studio_se . . . | 6/13/2001 3:46 PM | 5,565 |
| enable_performance_monitor . . . | 6/13/2001 3:46 PM | 4,779 |
| enabling_{—} | 6/13/2001 3:46 PM | 3,180 |
| or_disabling_alarms . . . | | |
| encrypt_archive.htm | 6/13/2001 3:46 PM | 10,202 |
| examples.htm | 6/13/2001 3:46 PM | 5,687 |
| example_{—} | 6/13/2001 3:46 PM | 6,418 |
| of_coldfusion_studi . . . | | |
| export_{—} | 6/13/2001 3:46 PM | 5,431 |
| certificate_public_key . . . | | |
| features_{—} | 6/13/2001 3:46 PM | 14,518 |
| in_coldfusion_enter . . . | | |
| features_{—} | 6/13/2001 3:46 PM | 18,324 |
| only_available_in_c . . . | | |
| files_directories_tab.htm | 6/13/2001 3:46 PM | 12,619 |
| filter.htm | 6/13/2001 3:46 PM | 8,079 |
| flsuh.gif | 6/13/2001 3:46 PM | 7,600 |
| ftsbody.htm | 6/13/2001 3:46 PM | 222,053 |
| ftsdhtml.htm | 6/13/2001 3:46 PM | 774 |
| ftsform.htm | 6/13/2001 3:46 PM | 1,019 |
| generating_archive.htm | 6/13/2001 3:46 PM | 10,948 |
| handle.htm | 6/13/2001 3:46 PM | 3,214 |
| headquarters.htm | 6/13/2001 3:46 PM | 6,809 |
| idcfinf.htm | 6/13/2001 3:46 PM | 20,754 |
| idxbody.htm | 6/13/2001 3:46 PM | 237,720 |
| idxdhtml.htm | 6/13/2001 3:46 PM | 759 |
| idxform.htm | 6/13/2001 3:46 PM | 1,132 |
| idxlist.htm | 6/13/2001 3:46 PM | 222,929 |
| implement_{—} | 6/13/2001 3:46 PM | 5,494 |
| coldfusion_admini . . . | | |
| implement_rds_security.htm | 6/13/2001 3:46 PM | 5,907 |
| implement_sandbox_security . . . | 6/13/2001 3:46 PM | 5,843 |
| implement_user_security.htm | 6/13/2001 3:46 PM | 6,197 |
| import_{—} | 6/13/2001 3:46 PM | 17,633 |
| certificates_to_coldfus . . . | | |
| javaapplet.htm | 6/13/2001 3:46 PM | 7,430 |
| javaappletpage.gif | 6/13/2001 3:46 PM | 7,588 |
| jvmandjava.htm | 6/13/2001 3:46 PM | 14,528 |
| key_{—} | 6/13/2001 3:46 PM | 7,716 |
| features_of_coldfusion_. . . | | |
| keywords.htm | 6/13/2001 3:46 PM | 3,817 |
| knowledge_base.htm | 6/13/2001 3:46 PM | 5,457 |
| launch_log_viewer.htm | 6/13/2001 3:46 PM | 5,426 |
| leftarrow.gif | 6/13/2001 3:46 PM | 172 |
| lock.gif | 6/13/2001 3:46 PM | 960 |
| log_file_format.htm | 6/13/2001 3:46 PM | 18,370 |
| log_{—} | 6/13/2001 3:46 PM | 5,004 |
| file_format_consideration . . . | | |
| logexample.gif | 6/13/2001 3:46 PM | 2,278 |
| logfiles.htm | 6/13/2001 3:46 PM | 12,848 |
| logfilespage.gif | 6/13/2001 3:46 PM | 7,206 |
| logsettings.htm | 6/13/2001 3:46 PM | 12,885 |
| logtypes.htm | 6/13/2001 3:46 PM | 15,978 |
| logviewer.gif | 6/13/2001 3:46 PM | 22,264 |
| logviewer.htm | 6/13/2001 3:46 PM | 8,270 |
| manage_verity_collections.htm | 6/13/2001 3:46 PM | 7,831 |
| memoryvar.gif | 6/13/2001 3:46 PM | 5,137 |
| mgeclivar.htm | 6/13/2001 3:46 PM | 12,654 |
| migclivar.htm | 6/13/2001 3:46 PM | 12,219 |
| mnglckvar.htm | 6/13/2001 3:46 PM | 11,039 |
| mngmemvar.htm | 6/13/2001 3:46 PM | 5,958 |
| mngpolicy.htm | 6/13/2001 3:46 PM | 7,977 |
| mngrules.htm | 6/13/2001 3:46 PM | 17,070 |
| mnguserdir.htm | 6/13/2001 3:46 PM | 6,973 |
| mon_siteperform.htm | 6/13/2001 3:46 PM | 13,158 |
| modifying_a_site_archive.htm | 6/13/2001 3:46 PM | 10,165 |
| modifying_{—} | 6/13/2001 3:46 PM | 7,982 |
| variable_definition . . . | | |
| monitoring_devices.htm | 6/13/2001 3:46 PM | 3,732 |
| navframe.htm | 6/13/2001 3:46 PM | 2,822 |
| navigating_topics.htm | 6/13/2001 3:46 PM | 5,372 |
| navpane1.htm | 6/13/2001 3:46 PM | 1,461 |
| navpane2.htm | 6/13/2001 3:46 PM | 6,824 |
| nsdnsfix.htm | 6/13/2001 3:46 PM | 1,193 |
| nsdnsfix.jar | 6/13/2001 3:46 PM | 2,875 |
| one-time.htm | 6/13/2001 3:46 PM | 4,328 |
| online_help.htm | 6/13/2001 3:46 PM | 4,361 |
| other_helpful_resources.htm | 6/13/2001 3:46 PM | 8,301 |
| overview_haa.htm | 6/13/2001 3:46 PM | 6,915 |
| overview_lb.htm | 6/13/2001 3:46 PM | 8,173 |
| overview_{—} | 6/13/2001 3:46 PM | 5,392 |
| of_advanced_optio . . . | | |
| overview_{—} | 6/13/2001 3:46 PM | 8,218 |
| of_advanced_secur . . . | | |
| safe.gif | 6/13/2001 3:46 PM | 941 |
| overview_{—} | 6/13/2001 3:46 PM | 7,720 |
| of_basic_configurat . . . | | |
| overview_{—} | 6/13/2001 3:46 PM | 4,973 |
| of_basic_security . . . | | |
| overview_{—} | 6/13/2001 3:46 PM | 5,990 |
| of_basic_troublesh . . . | | |
| overview_{—} | 6/13/2001 3:46 PM | 7,668 |
| of_coldfusion_data . . . | | |
| overview_{—} | 6/13/2001 3:46 PM | 6,727 |
| of_coldfusion_perfo . . . | | |
| overview_{—} | 6/13/2001 3:46 PM | 5,113 |
| of_debugging_setti . . . | | |
| overview_of_mib.htm | 6/13/2001 3:46 PM | 8,806 |
| overview_{—} | 6/13/2001 3:46 PM | 8,721 |
| of_optional_configu . . . | | |
| overview_{—} | 6/13/2001 3:46 PM | 12,691 |
| of_server_settings . . . | | |
| overview_{—} | 6/13/2001 3:46 PM | 5,445 |
| of_services_and_pr . . . | | |
| overview_of_site_archiving.htm | 6/13/2001 3:46 PM | 6,250 |
| policyimage.gif | 6/13/2001 3:46 PM | 4,231 |
| overview_of_uninstall.htm | 6/13/2001 3:46 PM | 4,398 |
| overview_{—} | 6/13/2001 3:46 PM | 7,498 |
| of_verity_collection . . . | | |
| perforancesummary.gif | 6/13/2001 3:46 PM | 7,077 |
| popvercllx.htm | 6/13/2001 3:46 PM | 7,929 |
| probe_suspended.htm | 6/13/2001 3:46 PM | 3,665 |
| probe_types.htm | 6/13/2001 3:46 PM | 7,392 |
| prtshrddat.htm | 6/13/2001 3:46 PM | 6,435 |
| public_key.htm | 6/13/2001 3:46 PM | 3,373 |
| queuedreport.gif | 6/13/2001 3:46 PM | 10,248 |
| queuedreq.htm | 6/13/2001 3:46 PM | 7,290 |
| recurring.htm | 6/13/2001 3:46 PM | 4,555 |
| regseccon.htm | 6/13/2001 3:46 PM | 19,022 |
| release_notes.htm | 6/13/2001 3:46 PM | 5,324 |
| requestprogress.htm | 6/13/2001 3:46 PM | 7,350 |
| requests.htm | 6/13/2001 3:46 PM | 7,524 |
| requestsinprogressreport.gif | 6/13/2001 3:46 PM | 9,364 |
| requestsreport.gif | 6/13/2001 3:46 PM | 12,658 |
| restrictdebug.gif | 6/13/2001 3:46 PM | 1,634 |
| restoring_an_archive.htm | 6/13/2001 3:46 PM | 11,424 |
| restricting_load_balancing.htm | 6/13/2001 3:46 PM | 7,944 |
| rightarrow.gif | 6/13/2001 3:46 PM | 189 |
| rstrdebug.htm | 6/13/2001 3:46 PM | 5,993 |
| rulesforpolicy.htm | 6/13/2001 3:46 PM | 6,199 |
| sales.htm | 6/13/2001 3:46 PM | 6,805 |
| sandbox.gif | 6/13/2001 3:46 PM | 3,229 |
| sched_build.htm | 6/13/2001 3:46 PM | 6,079 |
| schedarchivebut.gif | 6/13/2001 3:46 PM | 1,036 |
| schedtask.htm | 6/13/2001 3:46 PM | 5,912 |
| schedtaskpage.gif | 6/13/2001 3:46 PM | 16,337 |
| schedule_{—} | 6/13/2001 3:46 PM | 19,690 |
| backup_of_log_file . . . | | |
| schedule_task_overview.htm | 6/13/2001 3:46 PM | 5,610 |
| scheduled_tasks_tab.htm | 6/13/2001 3:46 PM | 7,250 |
| seccache.gif | 6/13/2001 3:46 PM | 10,225 |
| seccontext.gif | 6/13/2001 3:46 PM | 1,906 |
| secdatsrc.htm | 6/13/2001 3:46 PM | 5,405 |
| secmap.htm | 6/13/2001 3:46 PM | 5,473 |
| secres.htm | 6/13/2001 3:46 PM | 19,446 |
| secsand.htm | 6/13/2001 3:46 PM | 22,478 |
| secservcache.gif | 6/13/2001 3:46 PM | 9,980 |
| secserver.gif | 6/13/2001 3:46 PM | 9,079 |
| secure_the_coldfusion_admi . . . | 6/13/2001 3:46 PM | 5,927 |
| selcfset.htm | 6/13/2001 3:46 PM | 20,861 |
| select_a_security_level.htm | 6/13/2001 3:46 PM | 7,811 |
| server_thresholds.htm | 6/13/2001 3:46 PM | 5,921 |
| set_{—} | 6/13/2001 3:46 PM | 7,723 |
| up_and_configure_mib_f . . . | | |
| set_{—} | 6/13/2001 3:46 PM | 6,998 |
| up_and_configure_mib_f . . . | | |
| set_{—} | 6/13/2001 3:46 PM | 6,341 |
| up_and_configure_mib_f . . . | | |
| setcacpref.htm | 6/13/2001 3:46 PM | 11,593 |
| setcfpsswrd.htm | 6/13/2001 3:46 PM | 5,005 |
| setcfstdpass.htm | 6/13/2001 3:46 PM | 4,975 |
| setcftag.htm | 6/13/2001 3:46 PM | 5,244 |
| setchange.htm | 6/13/2001 3:46 PM | 5,279 |
| setsummary.htm | 6/13/2001 3:46 PM | 4,948 |
| setting_up_custom_probe.htm | 6/13/2001 3:46 PM | 9,875 |
| setting_up_default_probe.htm | 6/13/2001 3:46 PM | 9,627 |
| settings_tab.htm | 6/13/2001 3:46 PM | 7,140 |
| show_advanced_.htm | 6/13/2001 3:46 PM | 2,370 |
| signarchive.htm | 6/13/2001 3:46 PM | 11,517 |
| signed_certificates.htm | 6/13/2001 3:46 PM | 3,280 |
| sources_of_information.htm | 6/13/2001 3:46 PM | 5,474 |
| specify_{—} | 6/13/2001 3:46 PM | 6,972 |
| resources_to_protect . . . | | |
| specifying_recipients.htm | 6/13/2001 3:46 PM | 6,337 |
| start_and_stop_coldfusion.htm | 6/13/2001 3:46 PM | 15,606 |
| statssum.htm | 6/13/2001 3:46 PM | 6,409 |
| statssum2.htm | 6/13/2001 3:46 PM | 7,007 |
| supplied_cfx_tag.htm | 6/13/2001 3:46 PM | 9,657 |
| supplied_{—} | 6/13/2001 3:46 PM | 14,791 |
| copytext_java_appl . . . | | |
| thread.htm | 6/13/2001 3:46 PM | 3,224 |
| supplied_probe_java_applet . . . | 6/13/2001 3:46 PM | 14,598 |
| supplied_server_java_applet . . . | 6/13/2001 3:46 PM | 14,603 |
| supported_load_balancing_d . . . | 6/13/2001 3:46 PM | 4,521 |
| suspending_probe_operation . . . | 6/13/2001 3:46 PM | 5,362 |
| tabframe.htm | 6/13/2001 3:46 PM | 847 |
| technical_support.htm | 6/13/2001 3:46 PM | 3,661 |
| threshold.htm | 6/13/2001 3:46 PM | 4,006 |
| throughput.htm | 6/13/2001 3:46 PM | 7,649 |
| throughputreport.gif | 6/13/2001 3:46 PM | 11,144 |
| timeoutrequestreport.gif | 6/13/2001 3:46 PM | 10,126 |
| timeoutrequests.htm | 6/13/2001 3:46 PM | 7,514 |
| tips_for_printing.htm | 6/13/2001 3:46 PM | 4,467 |
| tips_{—} | 6/13/2001 3:46 PM | 5,620 |
| for_working_with_micros . . . | | |
| tocdhtml.htm | 6/13/2001 3:46 PM | 47,705 |
| toclist.htm | 6/13/2001 3:46 PM | 57,221 |
| training.htm | 6/13/2001 3:46 PM | 3,455 |
| types_log_messages.htm | 6/13/2001 3:46 PM | 5,591 |
| types_{—} | 6/13/2001 3:46 PM | 6,957 |
| of_coldfusion_security . . . | | |
| types_of_notifications.htm | 6/13/2001 3:46 PM | 8,714 |
| uninstall_{—} | 6/13/2001 3:46 PM | 4,316 |
| coldfusion_server_i . . . | | |
| uninstall_{—} | 6/13/2001 3:46 PM | 4,304 |
| coldfusion_server_i . . . | | |
| uninstall_{—} | 6/13/2001 3:46 PM | 4,591 |
| coldfusion_server_i . . . | | |
| uninstall_{—} | 6/13/2001 3:46 PM | 5,203 |
| coldfusion_server_i . . . | | |
| userdir.gif | 6/13/2001 3:46 PM | 1,838 |
| usersforpolicy.htm | 6/13/2001 3:46 PM | 6,548 |
| using_full-text_search.htm | 6/13/2001 3:46 PM | 4,159 |
| using_left-hand_tabs.htm | 6/13/2001 3:46 PM | 4,446 |
| using_{—} | 6/13/2001 3:46 PM | 9,275 |
| the_timeframe_control . . . | | |
| using_variables_.htm | 6/13/2001 3:46 PM | 9,152 |
| vercfconf.htm | 6/13/2001 3:46 PM | 4,051 |
| vercfserv.htm | 6/13/2001 3:46 PM | 5,519 |
| verify_{—} | 6/13/2001 3:46 PM | 7,552 |
| coldfusion_data_sourc . . . | | |
| verifyarchive.htm | 6/13/2001 3:46 PM | 10,229 |
| verity_collections_tab.htm | 6/13/2001 3:46 PM | 7,289 |
| verity_supported_file_types.htm | 6/13/2001 3:46 PM | 10,932 |
| verityadd.gif | 6/13/2001 3:46 PM | 4,180 |
| veritypop.gif | 6/13/2001 3:46 PM | 4,464 |
| verk2.htm | 6/13/2001 3:46 PM | 6,434 |
| verwebserv.htm | 6/13/2001 3:46 PM | 4,569 |
| viewsearchbut.gif | 6/13/2001 3:46 PM | 1,032 |
| webconfig.bmp | 6/13/2001 3:46 PM | 79,478 |
| webhelp.cab | 6/13/2001 3:46 PM | 64,004 |
| webhelp.jar | 6/13/2001 3:46 PM | 90,354 |
| webhelp.zip | 6/13/2001 3:46 PM | 182,547 |
| webhelp0.cab | 6/13/2001 3:46 PM | 57,374 |
| webhelp0.zip | 6/13/2001 3:46 PM | 166,553 |
| webhelp4.js | 6/13/2001 3:46 PM | 53,432 |
| welcome.htm | 6/13/2001 3:46 PM | 7,292 |
| what_{—} | 6/13/2001 3:46 PM | 9,147 |
| s_new_in_this_release . . . | | |
| what_{—} | 6/13/2001 3:46 PM | 5,170 |
| you_can_do_in_coldfus . . . | | |
| why_security_is_important.htm | 6/13/2001 3:46 PM | 7,275 |
| windowsystray.gif | 6/13/2001 3:46 PM | 1,823 |
| homelink.cfm | 6/13/2001 3:52 PM | 2,276 |
| ArcWizBG.gif | 6/13/2001 3:46 PM | 9,712 |
| SecuredBySiteMinder.gif | 6/13/2001 3:46 PM | 1,366 |
| alert.gif | 6/13/2001 3:46 PM | 140 |
| allaire.gif | 6/13/2001 3:46 PM | 1,149 |
| apply_a.gif | 6/13/2001 3:46 PM | 269 |
| archive.gif | 6/13/2001 3:46 PM | 384 |
| archivebg.gif | 6/13/2001 3:46 PM | 11,895 |
| archivebg2.gif | 6/13/2001 3:46 PM | 11,575 |
| archivelefftbg.gif | 6/13/2001 3:46 PM | 2,779 |
| back.gif | 6/13/2001 3:46 PM | 387 |
| bluecurve.gif | 6/13/2001 3:46 PM | 2,799 |
| build.gif | 6/13/2001 3:46 PM | 384 |
| build_button.gif | 6/13/2001 3:46 PM | 384 |
| cancel_a.gif | 6/13/2001 3:46 PM | 309 |
| cf50brand.jpg | 6/13/2001 3:46 PM | 21,749 |
| clear.gif | 6/13/2001 3:46 PM | 43 |
| coldfusion50.gif | 6/13/2001 3:46 PM | 8,865 |
| coldfusion50admin.gif | 6/13/2001 3:46 PM | 2,157 |
| coldfusion50small.gif | 6/13/2001 3:46 PM | 3,052 |
| deletered.gif | 6/13/2001 3:46 PM | 377 |
| delete_button.gif | 6/13/2001 3:46 PM | 377 |
| divider.gif | 6/13/2001 3:46 PM | 37 |
| download.gif | 6/13/2001 3:46 PM | 370 |
| edit.gif | 6/13/2001 3:46 PM | 272 |
| edit_button.gif | 6/13/2001 3:46 PM | 272 |
| evaluation.gif | 6/13/2001 3:46 PM | 1,051 |
| expired.gif | 6/13/2001 3:46 PM | 1,325 |
| export.gif | 6/13/2001 3:46 PM | 598 |
| filterhelp.gif | 6/13/2001 3:46 PM | 255 |
| footerbg2000.gif | 6/13/2001 3:46 PM | 23,523 |
| greendot.gif | 6/13/2001 3:46 PM | 282 |
| headerbg.jpg | 6/13/2001 3:46 PM | 10,738 |
| headerbg2000.gif | 6/13/2001 3:46 PM | 20,863 |
| headerbg2000.jpg | 6/13/2001 3:46 PM | 19,309 |
| headerbg2000x2000.gif | 6/13/2001 3:46 PM | 15,900 |
| headerstub.jpg | 6/13/2001 3:46 PM | 1,804 |
| help.gif | 6/13/2001 3:46 PM | 189 |
| home.gif | 6/13/2001 3:46 PM | 178 |
| homebandbg2000.gif | 6/13/2001 3:46 PM | 10,812 |
| homeimage.jpg | 6/13/2001 3:46 PM | 20,012 |
| leftbgblue.gif | 6/13/2001 3:46 PM | 12,487 |
| leftbgblue1.gif | 6/13/2001 3:46 PM | 12,505 |
| lg.gif | 6/13/2001 3:46 PM | 817 |
| local_resources.gif | 6/13/2001 3:46 PM | 549 |
| loginbg.gif | 6/13/2001 3:46 PM | 1,009 |
| loginbg3.gif | 6/13/2001 3:46 PM | 1,008 |
| loginbg4.gif | 6/13/2001 3:46 PM | 1,007 |
| logout.gif | 6/13/2001 3:46 PM | 171 |
| mainbg.gif | 6/13/2001 3:46 PM | 487 |
| mmcoldfusion5.gif | 6/13/2001 3:46 PM | 1,899 |
| online_resources.gif | 6/13/2001 3:46 PM | 603 |
| rg.gif | 6/13/2001 3:46 PM | 817 |
| run_button.gif | 6/13/2001 3:46 PM | 272 |
| schedule.gif | 6/13/2001 3:46 PM | 399 |
| spacer.gif | 6/13/2001 3:46 PM | 43 |
| tabsbg.gif | 6/13/2001 3:46 PM | 346 |
| technical_support.gif | 6/13/2001 3:46 PM | 606 |
| toolbarbg.gif | 6/13/2001 3:46 PM | 507 |
| update.gif | 6/13/2001 3:46 PM | 251 |
| view.gif | 6/13/2001 3:46 PM | 622 |
| view_button.gif | 6/13/2001 3:46 PM | 622 |
| homepage.cfm | 6/13/2001 3:52 PM | 10,315 |
| buttonbar.cfm | 6/13/2001 3:52 PM | 3,147 |
| errormessage.cfm | 6/13/2001 3:52 PM | 739 |
| errors.cfm | 6/13/2001 3:52 PM | 463 |
| marginbottom.cfm | 6/13/2001 3:52 PM | 221 |
| margintop.cfm | 6/13/2001 3:52 PM | 259 |
| stdformbuttons.cfm | 6/13/2001 3:52 PM | 756 |
| wizardbuttonbar.cfm | 6/13/2001 3:52 PM | 1,664 |
| wizardfooter.cfm | 6/13/2001 3:52 PM | 781 |
| wizardheader.cfm | 6/13/2001 3:52 PM | 2,662 |
| index.cfm | 6/13/2001 3:52 PM | 2,198 |
| index.htm | 6/13/2001 3:46 PM | 54 |
| index.html | 6/13/2001 3:46 PM | 54 |
| leftnav.cfm | 6/13/2001 3:52 PM | 3,616 |
| linkdirect.cfm | 6/13/2001 3:52 PM | 5,433 |
| archiveexecute.cfm | 6/13/2001 3:52 PM | 1,172 |
| deletelog.cfm | 6/13/2001 3:52 PM | 1,821 |
| downloadlog.cfm | 6/13/2001 3:52 PM | 596 |
| index.cfm | 6/13/2001 3:52 PM | 6,033 |
| settings.cfm | 6/13/2001 3:52 PM | 10,778 |
| login.cfm | 6/13/2001 3:52 PM | 4,269 |
| _searchformfilter.cfm | 6/13/2001 3:52 PM | 12,521 |
| _searchformhistory.cfm | 6/13/2001 3:52 PM | 6,800 |
| _searchformhistory_save.cfm | 6/13/2001 3:52 PM | 2,413 |
| _searchformstats.cfm | 6/13/2001 3:52 PM | 4,435 |
| _searchlog_cfformat.cfm | 6/13/2001 3:52 PM | 6,196 |
| _searchlog_error.cfm | 6/13/2001 3:52 PM | 275 |
| _searchlog_other.cfm | 6/13/2001 3:52 PM | 654 |
| _searchlog_stats.cfm | 6/13/2001 3:52 PM | 2,514 |
| _searchloglogic.cfm | 6/13/2001 3:52 PM | 17,331 |
| _searchloglogic_cfformat.cfm | 6/13/2001 3:52 PM | 17,092 |
| _searchloglogic_other.cfm | 6/13/2001 3:52 PM | 1,183 |
| _searchloglogic_stats.cfm | 6/13/2001 3:52 PM | 6,287 |
| logtest.cfm | 6/13/2001 3:52 PM | 3,531 |
| reports.cfm | 6/13/2001 3:52 PM | 330 |
| schedulearchive.cfm | 6/13/2001 3:52 PM | 337 |
| searchform.cfm | 6/13/2001 3:52 PM | 1,981 |
| searchlog.cfm | 6/13/2001 3:52 PM | 4,137 |
| navreports.cfm | 6/13/2001 3:52 PM | 4,755 |
| navsecurity.cfm | 6/13/2001 3:52 PM | 4,537 |
| navserver.cfm | 6/13/2001 3:52 PM | 4,875 |
| registrydefaults.cfm | 6/13/2001 3:52 PM | 8,686 |
| deletetask.cfm | 6/13/2001 3:52 PM | 1,292 |
| index.cfm | 6/13/2001 3:52 PM | 213 |
| runtask.cfm | 6/13/2001 3:52 PM | 1,284 |
| scheduleedit.cfm | 6/13/2001 3:52 PM | 16,208 |
| scheduletasks.cfm | 6/13/2001 3:52 PM | 5,211 |
| tasksettings.cfm | 6/13/2001 3:52 PM | 3,034 |
| Application.cfm | 6/13/2001 3:52 PM | 2,876 |
| addresource.cfm | 6/13/2001 3:52 PM | 11,222 |
| advancedindex.cfm | 6/13/2001 3:52 PM | 42,019 |
| directorylist.cfm | 6/13/2001 3:52 PM | 2,748 |
| domainlinkusers.cfm | 6/13/2001 3:52 PM | 4,304 |
| drivelock.gif | 6/13/2001 3:46 PM | 890 |
| filedialog.cfm | 6/13/2001 3:52 PM | 2,376 |
| findmerge.log. | 6/13/2001 3:46 PM | 89 |
| 13-Mar-01.12.0 . . . | | |
| folderclosed_red.gif | 6/13/2001 3:46 PM | 881 |
| folderopen_red.gif | 6/13/2001 3:46 PM | 890 |
| generaterulename.cfm | 6/13/2001 3:52 PM | 2,976 |
| gettaglist.cfm | 6/13/2001 3:52 PM | 1,625 |
| index.cfm | 6/13/2001 3:52 PM | 19,148 |
| map.cfm | 6/13/2001 3:52 PM | 3,353 |
| policies.cfm | 6/13/2001 3:52 PM | 3,776 |
| policydetail.cfm | 6/13/2001 3:52 PM | 5,088 |
| policylinkrules.cfm | 6/13/2001 3:52 PM | 4,679 |
| policylinkusers.cfm | 6/13/2001 3:52 PM | 5,817 |
| policyrules.cfm | 6/13/2001 3:52 PM | 2,975 |
| policyusers.cfm | 6/13/2001 3:52 PM | 3,436 |
| removeresource.cfm | 6/13/2001 3:52 PM | 6,862 |
| resourceimplicitlock.gif | 6/13/2001 3:47 PM | 615 |
| resourcelock.gif | 6/13/2001 3:47 PM | 614 |
| resourcetypelock.gif | 6/13/2001 3:47 PM | 365 |
| resourcetypeunlock.gif | 6/13/2001 3:47 PM | 217 |
| resourceunlock.gif | 6/13/2001 3:47 PM | 390 |
| resourceview.cfm | 6/13/2001 3:52 PM | 28,593 |
| ruledetail.cfm | 6/13/2001 3:52 PM | 16,335 |
| rules.cfm | 6/13/2001 3:52 PM | 6,696 |
| sandbox.cfm | 6/13/2001 3:52 PM | 5,190 |
| sandboxdetail.cfm | 6/13/2001 3:52 PM | 7,005 |
| security.dsp | 6/13/2001 3:47 PM | 3,623 |
| securitycontext.cfm | 6/13/2001 3:52 PM | 4,965 |
| securitycontext.gif | 6/13/2001 3:47 PM | 244 |
| securitycontextdetail.cfm | 6/13/2001 3:52 PM | 30,578 |
| securitytreekids.cfm | 6/13/2001 3:52 PM | 3,203 |
| soxml.cfm | 6/13/2001 3:52 PM | 11,316 |
| userdirectories.cfm | 6/13/2001 3:52 PM | 4,570 |
| userdirectorydetail.cfm | 6/13/2001 3:52 PM | 20,395 |
| usereditor.cfm | 6/13/2001 3:52 PM | 5,594 |
| LDAPinfo.cfm | 6/13/2001 3:52 PM | 11,208 |
| ODBCinfo.cfm | 6/13/2001 3:52 PM | 11,220 |
| bottom.cfm | 6/13/2001 3:52 PM | 700 |
| cfrestart.bat | 6/13/2001 3:47 PM | 132 |
| confsitemnd.cfm | 6/13/2001 3:52 PM | 3,948 |
| dsncreate.cfm | 6/13/2001 3:52 PM | 3,209 |
| dsnverify.cfm | 6/13/2001 3:52 PM | 1,616 |
| errorfile.htm | 6/13/2001 3:47 PM | 12,574 |
| export50.cfm | 6/13/2001 3:52 PM | 10,958 |
| import.cfm | 6/13/2001 3:52 PM | 14,791 |
| index.htm | 6/13/2001 3:47 PM | 2,749 |
| intro.cfm | 6/13/2001 3:52 PM | 1,611 |
| preptables.cfm | 6/13/2001 3:52 PM | 1,791 |
| restartall.bat | 6/13/2001 3:47 PM | 267 |
| smbackup.cfm | 6/13/2001 3:52 PM | 2,106 |
| smbackupname.cfm | 6/13/2001 3:52 PM | 1,297 |
| smexport.cfm | 6/13/2001 3:52 PM | 878 |
| smimport.cfm | 6/13/2001 3:52 PM | 1,373 |
| smmigrate.cfm | 6/13/2001 3:52 PM | 1,860 |
| smnewpwd.cfm | 6/13/2001 3:52 PM | 1,470 |
| soxml.cfm | 6/13/2001 3:52 PM | 11,698 |
| smnewpwdaction.cfm | 6/13/2001 3:52 PM | 3,880 |
| smpassword.cfm | 6/13/2001 3:52 PM | 2,060 |
| smrestart1.bat | 6/13/2001 3:47 PM | 96 |
| smrestart2.bat | 6/13/2001 3:47 PM | 95 |
| smrestart3.bat | 6/13/2001 3:47 PM | 97 |
| smrestart4.bat | 6/13/2001 3:47 PM | 98 |
| smrestorebk.cfm | 6/13/2001 3:52 PM | 1,943 |
| smservices.cfm | 6/13/2001 3:52 PM | 1,410 |
| smservicex.cfm | 6/13/2001 3:52 PM | 203 |
| smupgrade.cfm | 6/13/2001 3:52 PM | 1,847 |
| switchreg.cfm | 6/13/2001 3:52 PM | 3,411 |
| top.cfm | 6/13/2001 3:52 PM | 5,260 |
| upgrade.bat | 6/13/2001 3:47 PM | 175 |
| securitywizard.htm | 6/13/2001 3:47 PM | 3,994 |
| securitywizard2.htm | 6/13/2001 3:47 PM | 2,190 |
| _clientvariables_add_apply.cfm | 6/15/2002 1:55 PM | 9,787 |
| basic_sec_admpwd.cfm | 6/13/2001 3:52 PM | 4,822 |
| basic_sec_studio.cfm | 6/13/2001 3:52 PM | 4,305 |
| basic_sec_tags.cfm | 6/13/2001 3:52 PM | 7,612 |
| caching.cfm | 6/13/2001 3:52 PM | 6,514 |
| clientvariables.cfm | 6/13/2001 3:52 PM | 9,087 |
| clientvariables_add.cfm | 6/13/2001 3:52 PM | 5,992 |
| access.cfm | 6/13/2001 3:52 PM | 907 |
| db2.cfm | 6/13/2001 3:52 PM | 928 |
| dbase.cfm | 6/13/2001 3:52 PM | 907 |
| informix.cfm | 6/13/2001 3:52 PM | 926 |
| mysql.cfm | 6/13/2001 3:52 PM | 947 |
| openingres.cfm | 6/13/2001 3:52 PM | 913 |
| oracle.cfm | 6/13/2001 3:52 PM | 907 |
| paradox.cfm | 6/13/2001 3:52 PM | 911 |
| postgresql.cfm | 6/13/2001 3:52 PM | 911 |
| sqlserver.cfm | 6/13/2001 3:52 PM | 911 |
| sybase.cfm | 6/13/2001 3:52 PM | 916 |
| index.cfm | 6/13/2001 3:52 PM | 208 |
| locking.cfm | 6/13/2001 3:52 PM | 7,301 |
| mail.cfm | 6/13/2001 3:52 PM | 7,791 |
| mappings.cfm | 6/13/2001 3:52 PM | 6,221 |
| memoryvariables.cfm | 6/13/2001 3:52 PM | 9,683 |
| server_settings.cfm | 6/13/2001 3:52 PM | 15,228 |
| source_control.cfm | 6/13/2001 3:52 PM | 6,511 |
| upgrade.cfm | 6/13/2001 3:52 PM | 8,476 |
| version.cfm | 6/13/2001 3:52 PM | 6,470 |
| siteminder-installation-guide . . . | 6/13/2001 3:47 PM | 2,008,088 |
| tabs.cfm | 6/13/2001 3:52 PM | 1,817 |
| topnav.cfm | 6/13/2001 3:52 PM | 8,379 |
| CFJava2.jar | 6/13/2001 3:43 PM | 82,569 |
| CFDirectoryTree.class | 6/13/2001 3:47 PM | 8,654 |
| CFNavigation.class | 6/13/2001 3:47 PM | 1,622 |
| CFNavigationApplet.class | 6/13/2001 3:47 PM | 1,184 |
| CFNetRouter.class | 6/13/2001 3:47 PM | 7,651 |
| CFRPCParameterException . . . | 6/13/2001 3:47 PM | 860 |
| CFRPCServerException.class | 6/13/2001 3:47 PM | 1,038 |
| CFServiceControl.class | 6/13/2001 3:47 PM | 6,635 |
| NetscapeApplet.class | 6/13/2001 3:47 PM | 635 |
| CFDATACell.class | 6/13/2001 3:47 PM | 1,292 |
| CFDATARow.class | 6/13/2001 3:47 PM | 1,351 |
| CFGRID.class | 6/13/2001 3:47 PM | 8,989 |
| CFGRIDActionButton.class | 6/13/2001 3:47 PM | 2,387 |
| CFGRIDActionbar.class | 6/13/2001 3:47 PM | 2,549 |
| CFGRIDCallBack.class | 6/13/2001 3:47 PM | 238 |
| CFGRIDCanvas.class | 6/13/2001 3:47 PM | 28,027 |
| CFGRIDCell.class | 6/13/2001 3:47 PM | 924 |
| CFGRIDColProperties.class | 6/13/2001 3:47 PM | 556 |
| CFGRIDImage.class | 6/13/2001 3:47 PM | 565 |
| CFGRIDList.class | 6/13/2001 3:47 PM | 544 |
| CFGRIDRow.class | 6/13/2001 3:47 PM | 741 |
| CFGRIDTextAttributes.class | 6/13/2001 3:47 PM | 1,555 |
| CFGridFormColumn.class | 6/13/2001 3:47 PM | 1,208 |
| CFSliderApplet.class | 6/13/2001 3:47 PM | 598 |
| CFTextApplet.class | 6/13/2001 3:47 PM | 586 |
| CFTree.class | 6/13/2001 3:47 PM | 10,177 |
| CFTreeFormApplet.class | 6/13/2001 3:47 PM | 1,013 |
| CFTreeItem.class | 6/13/2001 3:47 PM | 6,713 |
| Tester.class | 6/13/2001 3:47 PM | 1,282 |
| cfGridFormApplet.class | 6/13/2001 3:47 PM | 14,978 |
| cfslider.class | 6/13/2001 3:47 PM | 5,853 |
| cftext.class | 6/13/2001 3:47 PM | 2,687 |
| cftextfilter.class | 6/13/2001 3:47 PM | 614 |
| cftreeform.class | 6/13/2001 3:47 PM | 4,650 |
| copytext.class | 6/13/2001 3:47 PM | 1,634 |
| Assert.class | 6/13/2001 3:47 PM | 701 |
| FontUtils.class | 6/13/2001 3:47 PM | 1,843 |
| Format.class | 6/13/2001 3:47 PM | 1,515 |
| InsertionSort.class | 6/13/2001 3:47 PM | 1,073 |
| ProfileFile.class | 6/13/2001 3:47 PM | 2,999 |
| QuickSort.class | 6/13/2001 3:47 PM | 1,891 |
| QuickSortStack.class | 6/13/2001 3:47 PM | 289 |
| SortCallback.class | 6/13/2001 3:47 PM | 214 |
| TextUtils.class | 6/13/2001 3:47 PM | 2,403 |
| TypeConversionException.cl . . . | 6/13/2001 3:47 PM | 254 |
| TypelessValue.class | 6/13/2001 3:47 PM | 1,866 |
| netHelpers.class | 6/13/2001 3:47 PM | 862 |
| BooleanElement.class | 6/13/2001 3:47 PM | 722 |
| BreakElement.class | 6/13/2001 3:47 PM | 449 |
| ChrFunction.class | 6/13/2001 3:47 PM | 746 |
| CompareFunction.class | 6/13/2001 3:47 PM | 787 |
| CompareNoCaseFunction.cl . . . | 6/13/2001 3:47 PM | 852 |
| ContinueElement.class | 6/13/2001 3:47 PM | 455 |
| CustomElement.class | 6/13/2001 3:47 PM | 2,599 |
| DollarExpressionFilter.class | 6/13/2001 3:47 PM | 2,521 |
| ElseElement.class | 6/13/2001 3:47 PM | 534 |
| ElseIfElement.class | 6/13/2001 3:47 PM | 388 |
| ExpressionException.class | 6/13/2001 3:47 PM | 841 |
| ExpressionFilter.class | 6/13/2001 3:47 PM | 248 |
| ExpressionFilterContext.class | 6/13/2001 3:47 PM | 1,332 |
| ExpressionLexer.class | 6/13/2001 3:47 PM | 1,269 |
| ExpressionParser.class | 6/13/2001 3:47 PM | 6,637 |
| ExpressionText.class | 6/13/2001 3:47 PM | 367 |
| FindFunction.class | 6/13/2001 3:47 PM | 758 |
| FindNoCaseFunction.class | 6/13/2001 3:47 PM | 823 |
| Function.class | 6/13/2001 3:47 PM | 2,943 |
| FunctionCallException.class | 6/13/2001 3:47 PM | 713 |
| FunctionInfo.class | 6/13/2001 3:47 PM | 507 |
| FunctionLibrary.class | 6/13/2001 3:47 PM | 906 |
| IfElement.class | 6/13/2001 3:47 PM | 1,038 |
| IncludeElement.class | 6/13/2001 3:47 PM | 1,371 |
| LCaseFunction.class | 6/13/2001 3:47 PM | 770 |
| LTrimFunction.class | 6/13/2001 3:47 PM | 931 |
| LeftFunction.class | 6/13/2001 3:47 PM | 900 |
| LenFunction.class | 6/13/2001 3:47 PM | 727 |
| LoopBreakException.class | 6/13/2001 3:47 PM | 260 |
| LoopContinueException.class | 6/13/2001 3:47 PM | 263 |
| LoopElement.class | 6/13/2001 3:47 PM | 3,662 |
| MidFunction.class | 6/13/2001 3:47 PM | 940 |
| ParameterExistsFunction.class | 6/13/2001 3:47 PM | 991 |
| RTrimFunction.class | 6/13/2001 3:47 PM | 933 |
| RepeatStringFunction.class | 6/13/2001 3:47 PM | 983 |
| RightFunction.class | 6/13/2001 3:47 PM | 902 |
| RuntimeFunctionLibrary.class | 6/13/2001 3:47 PM | 484 |
| SetElement.class | 6/13/2001 3:47 PM | 1,703 |
| StringFunctionLibrary.class | 6/13/2001 3:47 PM | 1,282 |
| SymbolTable.class | 6/13/2001 3:47 PM | 1,834 |
| SymbolTableException.class | 6/13/2001 3:47 PM | 532 |
| Tag.class | 6/13/2001 3:47 PM | 3,102 |
| TagAttributes.class | 6/13/2001 3:47 PM | 1,993 |
| TagParseException.class | 6/13/2001 3:47 PM | 721 |
| TagParser.class | 6/13/2001 3:47 PM | 8,764 |
| TemplateCustomTag.class | 6/13/2001 3:47 PM | 392 |
| TemplateElement.class | 6/13/2001 3:47 PM | 844 |
| TemplateException.class | 6/13/2001 3:47 PM | 3,498 |
| TemplateOutput.class | 6/13/2001 3:47 PM | 890 |
| TemplateParser.class | 6/13/2001 3:47 PM | 8,098 |
| TemplateRuntimeContext.class | 6/13/2001 3:47 PM | 951 |
| TemplateTagElement.class | 6/13/2001 3:47 PM | 2,104 |
| TextElement.class | 6/13/2001 3:47 PM | 718 |
| Token.class | 6/13/2001 3:47 PM | 2,744 |
| TrimFunction.class | 6/13/2001 3:47 PM | 761 |
| UCaseFunction.class | 6/13/2001 3:47 PM | 770 |
| cf-j2re-win.cab | 6/13/2001 3:43 PM | 5,073,743 |
| CDDrive.gif | 6/13/2001 3:47 PM | 907 |
| Computer.gif | 6/13/2001 3:47 PM | 897 |
| DefaultImage.gif | 6/13/2001 3:47 PM | 4,846 |
| Document.gif | 6/13/2001 3:47 PM | 878 |
| Elements.gif | 6/13/2001 3:47 PM | 885 |
| Eraser.gif | 6/13/2001 3:47 PM | 889 |
| Floppy.gif | 6/13/2001 3:47 PM | 874 |
| FolderClosed.gif | 6/13/2001 3:47 PM | 881 |
| FolderOpen.gif | 6/13/2001 3:47 PM | 890 |
| HardDrive.gif | 6/13/2001 3:47 PM | 890 |
| NetworkDrive.gif | 6/13/2001 3:47 PM | 882 |
| NewFile.gif | 6/13/2001 3:47 PM | 866 |
| OpenFile.gif | 6/13/2001 3:47 PM | 906 |
| SaveFile.gif | 6/13/2001 3:47 PM | 882 |
| TagList.gif | 6/13/2001 3:47 PM | 865 |
| admin.gif | 6/13/2001 3:47 PM | 1,552 |
| adminx.gif | 6/13/2001 3:47 PM | 1,974 |
| cflogo.gif | 6/13/2001 3:47 PM | 14,136 |
| delete.gif | 6/13/2001 3:47 PM | 873 |
| edit.gif | 6/13/2001 3:47 PM | 1,499 |
| editx.gif | 6/13/2001 3:47 PM | 1,971 |
| insert.gif | 6/13/2001 3:47 PM | 870 |
| options.gif | 6/13/2001 3:47 PM | 1,545 |
| optionsx.gif | 6/13/2001 3:47 PM | 1,996 |
| preview.gif | 6/13/2001 3:47 PM | 1,553 |
| previewx.gif | 6/13/2001 3:47 PM | 1,958 |
| sortasc.gif | 6/13/2001 3:47 PM | 888 |
| sortdesc.gif | 6/13/2001 3:47 PM | 890 |
| AWTCompatibility.class | 6/13/2001 3:47 PM | 5,179 |
| AWTComponentView.class | 6/13/2001 3:47 PM | 1,817 |
| Alert.class | 6/13/2001 3:47 PM | 9,038 |
| AlertContentView.class | 6/13/2001 3:47 PM | 1,561 |
| AppletResources.class | 6/13/2001 3:47 PM | 4,552 |
| Application.class | 6/13/2001 3:47 PM | 17,638 |
| ApplicationEvent.class | 6/13/2001 3:47 PM | 2,172 |
| ApplicationEventFilter.class | 6/13/2001 3:47 PM | 886 |
| ApplicationObserver.class | 6/13/2001 3:47 PM | 567 |
| Autoscroller.class | 6/13/2001 3:47 PM | 838 |
| BezelBorder.class | 6/13/2001 3:47 PM | 7,995 |
| Bitmap.class | 6/13/2001 3:47 PM | 13,947 |
| BitmapObserver.class | 6/13/2001 3:47 PM | 1,466 |
| Border.class | 6/13/2001 3:47 PM | 1,903 |
| BrokenImageAttachment.class | 6/13/2001 3:47 PM | 1,157 |
| Button.class | 6/13/2001 3:47 PM | 22,171 |
| CheckButtonImage.class | 6/13/2001 3:47 PM | 2,948 |
| Clipboard.class | 6/13/2001 3:47 PM | 271 |
| Color.class | 6/13/2001 3:47 PM | 5,122 |
| ColorChooser.class | 6/13/2001 3:47 PM | 5,788 |
| ColorWell.class | 6/13/2001 3:47 PM | 6,203 |
| CommandEvent.class | 6/13/2001 3:47 PM | 1,436 |
| CommandFilter.class | 6/13/2001 3:47 PM | 1,137 |
| ContainerView.class | 6/13/2001 3:47 PM | 9,413 |
| DebugGraphics.class | 6/13/2001 3:47 PM | 13,525 |
| DebugGraphicsColorFilter.cl . . . | 6/13/2001 3:47 PM | 587 |
| DebugGraphicsInfo.class | 6/13/2001 3:47 PM | 1,327 |
| DragDestination.class | 6/13/2001 3:47 PM | 368 |
| DragSession.class | 6/13/2001 3:47 PM | 6,032 |
| DragSource.class | 6/13/2001 3:47 PM | 412 |
| DragView.class | 6/13/2001 3:47 PM | 3,874 |
| DragWell.class | 6/13/2001 3:47 PM | 4,805 |
| DrawingSequence.class | 6/13/2001 3:47 PM | 6,461 |
| EmptyBorder.class | 6/13/2001 3:47 PM | 1,212 |
| DrawingSequenceOwner.class | 6/13/2001 3:47 PM | 330 |
| Event.class | 6/13/2001 3:47 PM | 1,888 |
| EventFilter.class | 6/13/2001 3:47 PM | 263 |
| EventLoop.class | 6/13/2001 3:47 PM | 4,036 |
| EventProcessor.class | 6/13/2001 3:47 PM | 258 |
| ExtendedTarget.class | 6/13/2001 3:47 PM | 623 |
| ExternalWindow.class | 6/13/2001 3:47 PM | 13,078 |
| FastStringBuffer.class | 6/13/2001 3:47 PM | 3,571 |
| FileChooser.class | 6/13/2001 3:47 PM | 1,814 |
| Font.class | 6/13/2001 3:47 PM | 9,999 |
| FontChooser.class | 6/13/2001 3:47 PM | 7,995 |
| FontItem.class | 6/13/2001 3:47 PM | 782 |
| FontMetrics.class | 6/13/2001 3:47 PM | 3,690 |
| FormElement.class | 6/13/2001 3:47 PM | 244 |
| FoundationApplet.class | 6/13/2001 3:47 PM | 6,931 |
| FoundationAppletStub.class | 6/13/2001 3:47 PM | 2,354 |
| FoundationCheckMenuItem.c . . . | 6/13/2001 3:47 PM | 1,447 |
| FoundationDialog.class | 6/13/2001 3:47 PM | 2,221 |
| FoundationFrame.class | 6/13/2001 3:47 PM | 2,080 |
| FoundationMenuItem.class | 6/13/2001 3:47 PM | 1,429 |
| FoundationPanel.class | 6/13/2001 3:47 PM | 4,938 |
| FoundationWindow.class | 6/13/2001 3:47 PM | 2,118 |
| Graphics.class | 6/13/2001 3:47 PM | 14,221 |
| GraphicsState.class | 6/13/2001 3:47 PM | 1,889 |
| GridLayout.class | 6/13/2001 3:47 PM | 4,439 |
| HRTextAttachment.class | 6/13/2001 3:47 PM | 1,239 |
| HTMLElement.class | 6/13/2001 3:47 PM | 330 |
| HTMLParser.class | 6/13/2001 3:47 PM | 12,862 |
| HTMLParsingException.class | 6/13/2001 3:47 PM | 506 |
| HTMLParsingRules.class | 6/13/2001 3:47 PM | 5,213 |
| HTMLTokenGenerator.class | 6/13/2001 3:47 PM | 6,439 |
| Image.class | 6/13/2001 3:47 PM | 4,023 |
| ImageAttachment.class | 6/13/2001 3:47 PM | 2,390 |
| KeyEvent.class | 6/13/2001 3:47 PM | 4,276 |
| ImageSequence.class | 6/13/2001 3:47 PM | 6,175 |
| InternalAlertBorder.class | 6/13/2001 3:47 PM | 1,490 |
| InternalWindow.class | 6/13/2001 3:47 PM | 28,578 |
| InternalWindowBorder.class | 6/13/2001 3:47 PM | 5,625 |
| JDK11AirLock.class | 6/13/2001 3:47 PM | 2,079 |
| KeyStroke.class | 6/13/2001 3:47 PM | 2,466 |
| KeyboardArrow.class | 6/13/2001 3:47 PM | 1,350 |
| Label.class | 6/13/2001 3:47 PM | 5,894 |
| LayoutManager.class | 6/13/2001 3:47 PM | 333 |
| LineBorder.class | 6/13/2001 3:47 PM | 2,614 |
| ListItem.class | 6/13/2001 3:47 PM | 7,274 |
| ListView.class | 6/13/2001 3:47 PM | 15,304 |
| Menu.class | 6/13/2001 3:47 PM | 9,521 |
| MenuBorder.class | 6/13/2001 3:47 PM | 2,671 |
| MenuItem.class | 6/13/2001 3:47 PM | 13,430 |
| MenuShortcut.class | 6/13/2001 3:47 PM | 249 |
| MenuView.class | 6/13/2001 3:47 PM | 13,188 |
| ModalDialogManager.class | 6/13/2001 3:47 PM | 621 |
| MouseEvent.class | 6/13/2001 3:47 PM | 2,367 |
| MouseFilter.class | 6/13/2001 3:47 PM | 886 |
| ObjectPool.class | 6/13/2001 3:47 PM | 2,378 |
| PackConstraints.class | 6/13/2001 3:47 PM | 4,841 |
| PackLayout.class | 6/13/2001 3:47 PM | 6,177 |
| Point.class | 6/13/2001 3:47 PM | 3,226 |
| Polygon.class | 6/13/2001 3:47 PM | 2,518 |
| Popup.class | 6/13/2001 3:47 PM | 12,604 |
| PopupItem.class | 6/13/2001 3:47 PM | 2,545 |
| Range.class | 6/13/2001 3:47 PM | 3,763 |
| Rect.class | 6/13/2001 3:47 PM | 8,913 |
| ResizeFilter.class | 6/13/2001 3:47 PM | 893 |
| RootView.class | 6/13/2001 3:47 PM | 31,237 |
| ScrollBar.class | 6/13/2001 3:47 PM | 19,644 |
| ScrollBarOwner.class | 6/13/2001 3:47 PM | 372 |
| ScrollGroup.class | 6/13/2001 3:47 PM | 10,729 |
| ScrollView.class | 6/13/2001 3:47 PM | 9,457 |
| ScrollViewLineBorder.class | 6/13/2001 3:47 PM | 1,280 |
| Scrollable.class | 6/13/2001 3:47 PM | 428 |
| Size.class | 6/13/2001 3:47 PM | 3,379 |
| Slider.class | 6/13/2001 3:47 PM | 10,936 |
| Sound.class | 6/13/2001 3:47 PM | 3,607 |
| SystemImages.class | 6/13/2001 3:47 PM | 24,915 |
| Target.class | 6/13/2001 3:47 PM | 252 |
| TargetChain.class | 6/13/2001 3:47 PM | 3,245 |
| TextAttachment.class | 6/13/2001 3:47 PM | 2,894 |
| TextBag.class | 6/13/2001 3:47 PM | 487 |
| TextField.class | 6/13/2001 3:47 PM | 31,474 |
| TextFieldOwner.class | 6/13/2001 3:47 PM | 608 |
| TextFilter.class | 6/13/2001 3:47 PM | 293 |
| TextParagraph.class | 6/13/2001 3:47 PM | 23,423 |
| TextParagraphFormat.class | 6/13/2001 3:47 PM | 5,578 |
| TextPositionInfo.class | 6/13/2001 3:47 PM | 4,094 |
| TextSelection.class | 6/13/2001 3:47 PM | 8,728 |
| TextStyleRun.class | 6/13/2001 3:47 PM | 11,540 |
| TextView.class | 6/13/2001 3:47 PM | 57,423 |
| TextViewHTMLContainer.class | 6/13/2001 3:47 PM | 4,088 |
| TextViewHTMLContainerImp . . . | 6/13/2001 3:47 PM | 7,459 |
| TextViewHTMLElement.class | 6/13/2001 3:47 PM | 1,666 |
| TextViewHTMLMarker.class | 6/13/2001 3:47 PM | 2,778 |
| TextViewHTMLMarkerImp.cl . . . | 6/13/2001 3:47 PM | 3,876 |
| TextViewHTMLString.class | 6/13/2001 3:47 PM | 1,553 |
| TextViewOwner.class | 6/13/2001 3:47 PM | 607 |
| Timer.class | 6/13/2001 3:47 PM | 4,770 |
| TimerQueue.class | 6/13/2001 3:47 PM | 3,378 |
| UpdateFilter.class | 6/13/2001 3:47 PM | 1,087 |
| VectorCache.class | 6/13/2001 3:47 PM | 1,084 |
| View.class | 6/13/2001 3:47 PM | 26,864 |
| Window.class | 6/13/2001 3:47 PM | 1,495 |
| WindowContentView.class | 6/13/2001 3:47 PM | 2,615 |
| WindowInvalidationAgent.class | 6/13/2001 3:47 PM | 922 |
| WindowOwner.class | 6/13/2001 3:47 PM | 512 |
| JDKClipboard.class | 6/13/2001 3:47 PM | 1,577 |
| JDKMenuShortcut.class | 6/13/2001 3:47 PM | 556 |
| Constructor.class | 6/13/2001 3:47 PM | 230 |
| Plan.class | 6/13/2001 3:47 PM | 16,131 |
| PlanLoader.class | 6/13/2001 3:47 PM | 5,392 |
| Script.class | 6/13/2001 3:47 PM | 5,657 |
| TargetProxy.class | 6/13/2001 3:47 PM | 4,048 |
| TargetProxyManager.class | 6/13/2001 3:47 PM | 3,389 |
| ViewProxy.class | 6/13/2001 3:47 PM | 5,286 |
| ASCIIArchiveLoader.class | 6/13/2001 3:47 PM | 15,039 |
| Archive.class | 6/13/2001 3:47 PM | 5,647 |
| Archiver.class | 6/13/2001 3:47 PM | 7,363 |
| ArchivingStack.class | 6/13/2001 3:47 PM | 1,921 |
| BariumArchiveLoader.class | 6/13/2001 3:47 PM | 8,429 |
| ClassInfo.class | 6/13/2001 3:47 PM | 2,035 |
| ClassTable.class | 6/13/2001 3:47 PM | 18,180 |
| Codable.class | 6/13/2001 3:47 PM | 1,171 |
| CodingException.class | 6/13/2001 3:47 PM | 353 |
| CompactInputStream.class | 6/13/2001 3:47 PM | 4,823 |
| CompactOutputStream.class | 6/13/2001 3:47 PM | 4,280 |
| Comparable.class | 6/13/2001 3:47 PM | 230 |
| Decoder.class | 6/13/2001 3:47 PM | 1,561 |
| DeserializationException.class | 6/13/2001 3:47 PM | 507 |
| Deserializer.class | 6/13/2001 3:47 PM | 5,284 |
| Encoder.class | 6/13/2001 3:47 PM | 1,503 |
| Enumeration.class | 6/13/2001 3:47 PM | 265 |
| ExternalCoder.class | 6/13/2001 3:47 PM | 584 |
| FormattingSerializer.class | 6/13/2001 3:47 PM | 6,745 |
| Hashtable.class | 6/13/2001 3:47 PM | 6,002 |
| HashtableEnumerator.class | 6/13/2001 3:47 PM | 1,026 |
| IdHashtable.class | 6/13/2001 3:47 PM | 1,799 |
| InconsistencyException.class | 6/13/2001 3:47 PM | 363 |
| NoSuchElementException.cl . . . | 6/13/2001 3:48 PM | 374 |
| PrimitiveCoder.class | 6/13/2001 3:48 PM | 5,445 |
| Serializer.class | 6/13/2001 3:48 PM | 4,693 |
| Sort.class | 6/13/2001 3:48 PM | 1,919 |
| TokenGenerator.class | 6/13/2001 3:48 PM | 7,053 |
| Unarchiver.class | 6/13/2001 3:48 PM | 8,675 |
| Vector.class | 6/13/2001 3:48 PM | 7,089 |
| VectorEnumerator.class | 6/13/2001 3:48 PM | 795 |
| ide.cfm | 6/13/2001 3:43 PM | 83 |
| wddx.js | 6/13/2001 3:43 PM | 21,657 |
| testing.cfm | 6/20/2002 1:17 PM | 174 |
| lay_ContentContainer.cfm | 7/11/2002 7:22 PM | 37 |
| lay_Footer.cfm | 7/11/2002 7:22 PM | 1,284 |
| lay_FooterHome.cfm | 7/11/2002 7:22 PM | 1,479 |
| lay_Global.cfm | 7/11/2002 7:22 PM | 755 |
| lay_GlobalMarketing.cfm | 7/11/2002 7:22 PM | 155 |
| lay_GlobalMarketingHeader . . . | 7/14/2002 1:58 PM | 12,804 |
| lay_Header.cfm | 8/2/2002 4:46 PM | 4,000 |
| lay_Home.cfm | 7/14/2002 1:58 PM | 882 |
| lay_Layout.cfm | 7/11/2002 7:22 PM | 769 |
| lay_LeftNav.cfm | 7/11/2002 7:22 PM | 33 |
| lay_PaymentWkshtHeader.cfm | 7/14/2002 1:58 PM | 4,191 |
| lay_PaymentWkshtWizardLa . . . | 7/11/2002 7:22 PM | 927 |
| lay_SchoolLanding.cfm | 7/14/2002 2:22 PM | 1,440 |
| lay_WizardLayout.cfm | 7/11/2002 7:22 PM | 915 |
| lay_GlobalMarketingFooter.cfm | 7/11/2002 7:22 PM | 1,771 |
| lay_FooterText.cfm | 7/18/2002 4:13 PM | 228 |
| act_Citizenship.cfm | 7/11/2002 7:22 PM | 2,303 |
| act_CPDisclosure.cfm | 6/19/2002 10:46 AM | 1,757 |
| act_CPSignup.cfm | 6/19/2002 10:46 AM | 8,332 |
| act_Disclosure.cfm | 7/11/2002 7:22 PM | 2,322 |
| act_FundingMethod.cfm | 7/11/2002 7:22 PM | 2,583 |
| act_IdentityVerification.cfm | 7/11/2002 7:22 PM | 2,716 |
| act_JointApplicant.cfm | 7/11/2002 7:22 PM | 10,525 |
| act_JointApplicantCitizenship . . . | 7/11/2002 7:22 PM | 2,204 |
| act_StudentInfo.cfm | 7/11/2002 7:22 PM | 12,219 |
| act_TestHarness.cfm | 7/11/2002 7:22 PM | 124,956 |
| act_Verification.cfm | 7/14/2002 12:26 PM | 6,633 |
| act_VerifyFirstCMAccount.cfm | 7/11/2002 7:22 PM | 1,154 |
| dsp_CancelOpenAccount.cfm | 7/11/2002 7:22 PM | 420 |
| dsp_CMConfirm.cfm | 7/11/2002 7:22 PM | 2,829 |
| dsp_Disclosure.cfm | 7/11/2002 7:22 PM | 4,761 |
| dsp_DisagreementError.cfm | 7/11/2002 7:22 PM | 1,619 |
| dsp_DisclosurePopUp.cfm | 7/11/2002 7:22 PM | 798 |
| dsp_DisclosureText.cfm | 7/11/2002 7:22 PM | 60,651 |
| dsp_DisclosureTextFormated . . . | 7/11/2002 7:22 PM | 63,551 |
| dsp_FundingMethod.cfm | 7/15/2002 10:55 AM | 3,904 |
| dsp_FundingWelcome.cfm | 7/11/2002 7:22 PM | 1,179 |
| dsp_IDCheckFailure.cfm | 7/11/2002 7:22 PM | 3,715 |
| dsp_IDCheckRetry.cfm | 7/11/2002 7:22 PM | 2,119 |
| dsp_JointApplicant.cfm | 7/11/2002 7:22 PM | 25,964 |
| dsp_JointAppNonresidentAlie . . . | 7/11/2002 7:22 PM | 1,847 |
| dsp_StudentInfo.cfm | 8/22/2002 5:15 PM | 41,291 |
| dsp_StudentNonresidentAlien . . . | 7/11/2002 7:22 PM | 1,850 |
| dsp_Verification.cfm | 7/16/2002 9:58 AM | 20,097 |
| dsp_Welcome.cfm | 7/17/2002 5:36 PM | 15,194 |
| fbx_Settings.cfm | 7/11/2002 7:22 PM | 459 |
| qry_InsertBankAccount.cfm | 7/11/2002 7:22 PM | 1,016 |
| qry_VerifyCPSignupMatches . . . | 7/11/2002 7:22 PM | 1,205 |
| qry_{—} | 7/11/2002 7:22 PM | 1,315 |
| VerifyStudentFirstCMAcc . . . | | |
| fbx_Switch.cfm | 7/11/2002 7:22 PM | 6,659 |
| url_Home.cfm | 7/11/2002 7:22 PM | 74 |
| lay_GlobalMarketingHeader . . . | 6/20/2002 3:14 PM | 4,739 |
| dsp_CPSignupLong.cfm | 7/14/2002 1:33 PM | 27,981 |
| dsp_CPSignup.cfm | 7/14/2002 1:25 PM | 21,423 |
| act_ChangePassword.cfm | 7/11/2002 7:22 PM | 2,929 |
| act_CPDisclosure.cfm | 7/16/2002 9:35 AM | 2,275 |
| act_CPSignup.cfm | 7/15/2002 9:11 AM | 10,955 |
| act_CPSignupLong.cfm | 7/15/2002 2:19 PM | 14,005 |
| act_DoCPLogin.cfm | 7/14/2002 1:49 PM | 3,392 |
| act_EnterPasswordKey.cfm | 7/11/2002 7:22 PM | 2,692 |
| act_ForgotPassword.cfm | 7/11/2002 7:22 PM | 2,073 |
| act_InsertStudentFunder.cfm | 7/11/2002 7:22 PM | 3,073 |
| act_{—} | 7/11/2002 7:22 PM | 1,254 |
| VerifyCPStudentEqCMAp . . . | | |
| dsp_ChangePassword.cfm | 7/11/2002 7:22 PM | 2,549 |
| dsp_CPConfirm.cfm | 7/11/2002 7:22 PM | 1,993 |
| dsp_CPDisclosure.cfm | 7/11/2002 7:22 PM | 3,262 |
| dsp_CPLogin.cfm | 7/11/2002 7:22 PM | 8,431 |
| dsp_CPSignup.cfm | 7/18/2002 8:41 AM | 21,527 |
| dsp_CPSignupLong.cfm | 7/19/2002 1:27 PM | 27,726 |
| dsp_DisclosurePopUp.cfm | 7/11/2002 7:22 PM | 797 |
| dsp_DisclosureText.cfm | 7/12/2002 2:02 PM | 36,653 |
| dsp_DisclosureTextFormated . . . | 7/12/2002 2:17 PM | 38,103 |
| dsp_EnterPasswordKey.cfm | 7/11/2002 7:22 PM | 2,861 |
| dsp_ForgotPassword.cfm | 7/11/2002 7:22 PM | 2,406 |
| dsp_PasswordLinkSent.cfm | 7/11/2002 7:22 PM | 1,005 |
| fbx_Settings.cfm | 7/11/2002 7:22 PM | 359 |
| fbx_Switch.cfm | 7/16/2002 9:35 AM | 4,563 |
| qry_CampusPayLogin.cfm | 7/11/2002 7:22 PM | 1,184 |
| qry_CheckCampusPayUsern . . . | 7/11/2002 7:22 PM | 890 |
| qry_InsertCPStudentInfo.cfm | 7/11/2002 7:22 PM | 1,249 |
| qry_InsertForgottenPassword . . . | 7/11/2002 7:22 PM | 1,069 |
| qry_InsertFunder.cfm | 7/11/2002 7:22 PM | 1,351 |
| qry_InsertFunderAddress.cfm | 7/14/2002 11:17 AM | 1,927 |
| qry_InsertHomeAddress.cfm | 7/11/2002 7:22 PM | 1,616 |
| qry_InsertJointAddress.cfm | 7/11/2002 7:22 PM | 1,700 |
| qry_InsertJointApplicantAddr . . . | 7/11/2002 7:22 PM | 1,833 |
| qry_InsertJointApplicantInfo . . . | 9/3/2002 2:29 PM | 3,353 |
| qry_InsertSchoolAddress.cfm | 7/11/2002 7:22 PM | 1,949 |
| qry_InsertStudentFunder.cfm | 7/11/2002 7:22 PM | 2,544 |
| qry_RetrieveStudent.cfm | 7/11/2002 7:22 PM | 988 |
| qry_RetrieveAccountInfoByE . . . | 7/11/2002 7:22 PM | 967 |
| qry_RetrieveForgottenPassw . . . | 7/11/2002 7:22 PM | 1,280 |
| qry_UpdatePassword.cfm | 7/11/2002 7:22 PM | 929 |
| qry_UpdateStudentInfo.cfm | 9/9/2002 2:09 PM | 4,052 |
| qry_{—} | 7/11/2002 7:22 PM | 1,327 |
| VerifyCPStudentEqCMAp . . . | | |
| url_ChangePassword.cfm | 7/11/2002 7:22 PM | 98 |
| url_EnterPasswordKey.cfm | 7/11/2002 7:22 PM | 100 |
| dsp_DisagreementError.cfm | 7/16/2002 9:35 AM | 1,550 |
| act_CheckingOpenAccount.cfm | 7/18/2002 9:17 AM | 3,376 |
| act_CheckingPayTuition.cfm | 9/3/2002 1:55 PM | 7,081 |
| act_CreateDummySSN.cfm | 7/11/2002 7:22 PM | 2,369 |
| act_CreditCardOpenAccount . . . | 7/18/2002 9:17 AM | 6,949 |
| act_CreditCardPayTuition.cfm | 7/17/2002 1:32 PM | 5,862 |
| act_OpenAccountACH.cfm | 6/19/2002 10:46 AM | 2,084 |
| act_OpenAccountCC.cfm | 6/19/2002 10:46 AM | 3,425 |
| fbx_Settings.cfm | 7/11/2002 7:23 PM | 322 |
| fbx_Switch.cfm | 7/11/2002 7:23 PM | 919 |
| act_CreateACHFile.cfm | 8/19/2002 1:46 PM | 12,342 |
| act_CreateDummySSN.cfm | 7/11/2002 7:23 PM | 2,305 |
| act_CreateJWUTransferPay . . . | 7/31/2002 12:42 PM | 3,421 |
| act_CreateMaintenance.cfm | 9/3/2002 1:49 PM | 7,929 |
| act_CreateMonetary.cfm | 7/17/2002 5:42 PM | 4,690 |
| act_GetAccountNumber.cfm | 7/11/2002 7:23 PM | 1,203 |
| act_GetValidBankHoldiays.cfm | 7/11/2002 7:23 PM | 1,925 |
| act_LyonsRoutingNumberRe . . . | 7/11/2002 7:23 PM | 1,565 |
| act_{—} | 7/11/2002 7:23 PM | 1,070 |
| MarkAsSentNewApplicati . . . | | |
| act_UpdateTransferStatus.cfm | 7/11/2002 7:23 PM | 96 |
| fbx_Settings.cfm | 9/9/2002 2:32 PM | 4,147 |
| fbx_Switch.cfm | 9/4/2002 9:33 AM | 4,148 |
| qry_CompleteACHTransactio . . . | 7/11/2002 7:23 PM | 979 |
| qry_CompleteNewMonetaryT . . . | 7/11/2002 7:23 PM | 461 |
| qry_RetrieveACHTransaction . . . | 7/18/2002 10:07 AM | 2,009 |
| qry_{—} | 7/11/2002 7:23 PM | 3,124 |
| RetrieveNewApplications . . . | | |
| qry_{—} | 7/17/2002 5:04 PM | 916 |
| RetrieveNewMonetaryTra . . . | | |
| qry_RetrievePendingJWUPay . . . | 7/31/2002 12:42 PM | 1,668 |
| qry_UpdateTransferStatus.cfm | 7/18/2002 2:37 PM | 1,523 |
| act_GetValidBankHolidays.cfm | 7/18/2002 2:23 PM | 1,721 |
| act_CreateLogFile.cfm | 9/4/2002 9:32 AM | 2,318 |
| qry_InsertACH.cfm | 7/11/2002 7:23 PM | 1,647 |
| qry_InsertACHTransaction.cfm | 7/11/2002 7:23 PM | 1,250 |
| qry_InsertACHTransfer.cfm | 7/16/2002 2:59 PM | 1,842 |
| qry_InsertCreditCard.cfm | 7/11/2002 7:23 PM | 1,796 |
| qry_InsertCreditCardAddress . . . | 7/11/2002 7:23 PM | 1,584 |
| qry_{—} | 7/11/2002 7:23 PM | 1,901 |
| InsertCreditCardBillingAd . . . | | |
| qry_InsertCreditCardTransact . . . | 7/11/2002 7:23 PM | 1,867 |
| qry_{—} | 6/19/2002 10:46 AM | 1,633 |
| InsertDefinerACHTransfe . . . | | |
| qry_InsertDefinerMonetaryTr . . . | 6/19/2002 10:46 AM | 1,850 |
| qry_{—} | 7/11/2002 7:23 PM | 1,983 |
| InsertFundAccountACHT . . . | | |
| qry_InsertFundAccountCredit . . . | 7/11/2002 7:23 PM | 2,008 |
| qry_InsertMonetaryTransfer . . . | 7/16/2002 2:59 PM | 1,964 |
| qry_{—} | 7/11/2002 7:23 PM | 2,023 |
| InsertOpenAccountACHT . . . | | |
| qry_InsertOpenAccountCredit . . . | 7/11/2002 7:23 PM | 1,994 |
| qry_InsertPayTuitionACHTra . . . | 7/11/2002 7:23 PM | 2,075 |
| qry_InsertPayTuitionCreditCa . . . | 7/11/2002 7:23 PM | 2,106 |
| qry_InsertTransfer.cfm | 7/16/2002 2:58 PM | 1,889 |
| qry_InsertVerisignTransfer.cfm | 7/7/2002 3:37 PM | 1,537 |
| qry_RetrieveBankAccountID . . . | 7/11/2002 7:23 PM | 987 |
| qry_RetrieveCMAccountNum . . . | 7/11/2002 7:23 PM | 802 |
| qry_RetrieveNextCMAccount . . . | 7/11/2002 7:23 PM | 814 |
| qry_RetrieveProgramBankAc . . . | 7/11/2002 7:23 PM | 1,117 |
| qry_UpdateCMAccountNumb . . . | 7/11/2002 7:23 PM | 782 |
| qry_InsertPayProgramACHTr . . . | 7/11/2002 7:23 PM | 1,977 |
| qry_InsertPayProgramCredit . . . | 7/11/2002 7:23 PM | 2,010 |
| qry_RetrieveTodaysSchedule . . . | 7/8/2002 2:22 PM | 1,709 |
| qry_RetrieveTodaysSchedule . . . | 7/29/2002 4:21 PM | 1,104 |
| qry_RetrieveTodaysSchedule . . . | 7/29/2002 4:22 PM | 1,591 |
| qry_UpdateTransactionStatus . . . | 7/11/2002 7:23 PM | 1,223 |
| qry_RetrieveTransactionInfo . . . | 7/17/2002 12:45 PM | 1,167 |
| qry_UpdateCreditCardTransa . . . | 7/11/2002 7:23 PM | 1,356 |
| qry_UpdateTransferStatus.cfm | 7/11/2002 7:23 PM | 1,187 |
| qry_RetrieveCCTransferID.cfm | 7/11/2002 7:23 PM | 936 |
| qry_RetrieveTransactionTran . . . | 7/11/2002 7:23 PM | 772 |
| act_{—} | 9/3/2002 1:57 PM | 5,836 |
| CheckingPayTuitionDefer . . . | | |
| act_CreditCardPayTuitionDef . . . | 7/17/2002 1:32 PM | 6,698 |
| act_CheckingPayProgram.cfm | 7/17/2002 8:33 AM | 2,414 |
| act_CreditCardPayProgram . . . | 7/17/2002 9:41 AM | 4,301 |
| act_CreditCardFundAccount . . . | 7/17/2002 9:41 AM | 4,576 |
| act_CheckingFundAccount.cfm | 7/17/2002 8:33 AM | 2,141 |
| act_ProcessScheduledTrans . . . | 7/19/2002 7:20 AM | 12,840 |
| act_Checking.cfm | 7/11/2002 7:23 PM | 7,812 |
| act_CheckingOpenAccount.cfm | 6/19/2002 10:46 AM | 3,497 |
| act_CheckingPayTuition.cfm | 6/19/2002 10:46 AM | 2,979 |
| act_CreateDummySSN.cfm | 7/11/2002 7:23 PM | 2,311 |
| act_CreditCard.cfm | 7/15/2002 4:29 PM | 8,674 |
| act_CreditCardOpenAccount . . . | 6/19/2002 10:46 AM | 5,996 |
| act_CreditCardPayTuition.cfm | 6/19/2002 10:46 AM | 3,565 |
| act_PayFlowPro.cfm | 7/19/2002 2:39 PM | 1,430 |
| dsp_Checking.cfm | 7/11/2002 7:23 PM | 10,928 |
| dsp_CreditCard.cfm | 7/15/2002 4:11 PM | 16,628 |
| fbx_Settings.cfm | 7/11/2002 7:23 PM | 510 |
| fbx_Switch.cfm | 7/11/2002 7:23 PM | 1,886 |
| act_AdjustmentsToStatement . . . | 7/11/2002 7:23 PM | 1,589 |
| act_PaymentMethod.cfm | 7/15/2002 2:55 PM | 2,420 |
| dsp_AdjustmentsToStatemen . . . | 7/11/2002 7:23 PM | 15,337 |
| dsp_CampusPayWelcome.cfm | 7/11/2002 7:23 PM | 6,006 |
| dsp_PaymentMethod.cfm | 7/15/2002 2:53 PM | 8,477 |
| dsp_PrintWorksheet.cfm | 7/11/2002 7:23 PM | 14,226 |
| dsp_PrintWorksheetPopup.cfm | 7/11/2002 7:23 PM | 14,844 |
| dsp_TuitionConfirmation.cfm | 7/16/2002 10:05 AM | 3,252 |
| dsp_TuitionJustPay.cfm | 7/11/2002 7:23 PM | 2,726 |
| dsp_Welcome.cfm | 7/11/2002 7:23 PM | 1,686 |
| dsp_WhatToExpect.cfm | 7/11/2002 7:23 PM | 3,630 |
| fbx_Settings.cfm | 7/11/2002 7:23 PM | 471 |
| fbx_Switch.cfm | 7/16/2002 3:43 PM | 4,956 |
| url_Home.cfm | 7/11/2002 7:23 PM | 74 |
| dsp_WorksheetWelcome.cfm | 7/12/2002 11:01 AM | 2,667 |
| qry_RetrieveCampusPayAddr . . . | 7/11/2002 7:23 PM | 1,055 |
| qry_RetrieveCampusPayProfi . . . | 7/11/2002 7:23 PM | 948 |
| qry_RetrieveCampusPayStud . . . | 7/11/2002 7:23 PM | 1,102 |
| qry_RetrieveProgramID.cfm | 7/11/2002 7:23 PM | 844 |
| qry_RetrievePeriodID.cfm | 7/11/2002 7:23 PM | 835 |
| qry_InsertWorksheet.cfm | 7/11/2002 7:23 PM | 6,523 |
| qry_UpdateWorksheet.cfm | 7/11/2002 7:23 PM | 5,820 |
| qry_RetrieveWorksheet.cfm | 7/16/2002 11:20 AM | 1,789 |
| dsp_CreditCard.cfm | 7/5/2002 1:00 PM | 16,670 |
| qry_DeleteWorksheet.cfm | 7/11/2002 7:23 PM | 914 |
| dsp_Worksheet.cfm | 8/2/2002 7:20 PM | 24,657 |
| fbx_Settings.cfm | 7/11/2002 7:23 PM | 473 |
| fbx_Switch.cfm | 8/2/2002 7:21 PM | 7,185 |
| dsp_CampusPayWelcome.cfm | 7/11/2002 7:23 PM | 5,685 |
| act_Worksheet.cfm | 8/2/2002 7:20 PM | 4,533 |
| dsp_DeferredPayment.cfm | 7/16/2002 8:56 AM | 9,242 |
| act_DeferredPayment.cfm | 7/11/2002 7:23 PM | 2,498 |
| dsp_PaymentMethod.cfm | 6/21/2002 3:14 PM | 5,858 |
| act_PaymentMethod.cfm | 6/21/2002 3:14 PM | 1,422 |
| dsp_TuitionConfirmation.cfm | 7/29/2002 4:21 PM | 4,296 |
| act_FullPayment.cfm | 7/11/2002 7:23 PM | 2,317 |
| dsp_FullPayment.cfm | 7/12/2002 11:09 AM | 6,723 |
| dsp_CallCenterCC.cfm | 7/19/2002 8:28 AM | 8,505 |
| dsp_WorksheetWelcome.cfm | 7/11/2002 7:23 PM | 2,815 |
| act_PaymentPlan.cfm | 7/16/2002 10:35 AM | 1,636 |
| dsp_PaymentPlan.cfm | 7/18/2002 4:31 PM | 3,443 |
| act_DeferredDisclosure.cfm | 7/11/2002 7:23 PM | 3,083 |
| dsp_DeferredDisclosure.cfm | 7/11/2002 7:23 PM | 4,143 |
| dsp_MailDone.cfm | 7/11/2002 7:23 PM | 1,989 |
| dsp_DisclosureText.cfm | 7/11/2002 7:23 PM | 1,102 |
| dsp_PrintableWorksheet.cfm | 8/2/2002 7:20 PM | 14,865 |
| act_SaveWorksheet.cfm | 7/11/2002 7:23 PM | 5,648 |
| url_SaveWorksheetConfirmat . . . | 7/11/2002 7:24 PM | 102 |
| dsp_SaveWorksheetConfirm . . . | 7/16/2002 9:40 AM | 3,023 |
| act_RetrieveWorksheetInfo.cfm | 7/11/2002 7:23 PM | 1,206 |
| dsp_DeferredDisclosureDisa . . . | 7/11/2002 7:23 PM | 1,082 |
| act_CallCenterCC.cfm | 7/11/2002 7:23 PM | 862 |
| act_WorksheetComplete.cfm | 7/11/2002 7:23 PM | 961 |
| dsp_WorksheetComplete.cfm | 7/18/2002 4:08 PM | 1,810 |
| dsp_DisclosurePopUp.cfm | 7/11/2002 7:23 PM | 788 |
| dsp_DisclosureTextFormated . . . | 7/11/2002 7:23 PM | 1,683 |
| dsp_NegBalance.cfm | 8/2/2002 7:20 PM | 2,542 |
| dsp_NegBalanceConfirm.cfm | 8/2/2002 7:20 PM | 2,346 |
| dsp_CorrectSchool.cfm | 7/16/2002 3:34 PM | 1,483 |
| url_CorrectSchool.cfm | 7/16/2002 3:13 PM | 107 |
| qry_InsertFailure.cfm | 7/11/2002 7:24 PM | 9,641 |
| qry_RetrieveEmailTemplate . . . | 7/11/2002 7:24 PM | 993 |
| qry_RetrieveSchoolInfo.cfm | 7/11/2002 7:24 PM | 1,003 |
| qry_RetrieveSchools.cfm | 7/11/2002 7:24 PM | 819 |
| qry_RetrieveStates.cfm | 7/11/2002 7:24 PM | 792 |
| qry_UpdateEmailTemplate.cfm | 7/11/2002 7:24 PM | 333 |
| qry_VerifyZipCodeCityState . . . | 7/11/2002 7:24 PM | 950 |
| dsp_GeneralError.cfm | 7/5/2002 12:37 PM | 1,171 |
| dsp_InvalidAction.cfm | 6/19/2002 3:19 PM | 1,130 |
| act_RISDStudentDatabaseRe . . . | 7/15/2002 7:35 AM | 1,778 |
| wiz_RISDTuitionWorksheet . . . | 8/2/2002 7:19 PM | 9,964 |
| fbx_Settings.cfm | 7/14/2002 1:57 PM | 451 |
| fbx_Switch.cfm | 7/19/2002 2:56 PM | 9,442 |
| dsp_Login.cfm | 7/11/2002 7:22 PM | 7,322 |
| url_CampusPayHome.cfm | 7/11/2002 7:22 PM | 84 |
| dsp_Home.cfm | 7/16/2002 8:40 AM | 6,856 |
| act_Login.cfm | 7/11/2002 7:22 PM | 2,809 |
| act_Logout.cfm | 7/14/2002 1:57 PM | 264 |
| dsp_Transfer.cfm | 7/17/2002 4:48 PM | 2,298 |
| dsp_TransferHistory.cfm | 7/16/2002 4:45 PM | 5,369 |
| dsp_ScheduledTransfer.cfm | 7/16/2002 5:03 PM | 5,074 |
| dsp_Accounts.cfm | 7/16/2002 11:54 AM | 6,010 |
| dsp_Profile.cfm | 7/18/2002 8:41 AM | 22,316 |
| qry_RetrieveTransactionHisto . . . | 7/19/2002 3:09 PM | 2,314 |
| qry_RetrieveProfile.cfm | 7/14/2002 12:36 PM | 2,656 |
| qry_UpdateProfileAddress.cfm | 7/14/2002 12:37 PM | 1,154 |
| qry_UpdateProfile.cfm | 7/14/2002 12:37 PM | 1,114 |
| qry_CheckEmailAddress.cfm | 7/11/2002 7:22 PM | 699 |
| qry_RetrieveAccounts.cfm | 7/11/2002 7:22 PM | 1,139 |
| qry_InsertCCAccount.cfm | 7/11/2002 7:22 PM | 1,222 |
| qry_DeleteCCAccount.cfm | 7/11/2002 7:22 PM | 694 |
| qry_InsertACHAccount.cfm | 7/11/2002 7:22 PM | 1,064 |
| qry_DeleteACHAccount.cfm | 7/11/2002 7:22 PM | 675 |
| qry_{—} | 7/11/2002 7:22 PM | 839 |
| RetrieveCCAccountDetail . . . | | |
| qry_RetrieveACHAccountDet . . . | 7/11/2002 7:22 PM | 744 |
| qry_DeleteACHTransaction.cfm | 7/11/2002 7:22 PM | 694 |
| qry_RetrieveScheduledTrans . . . | 9/3/2002 1:54 PM | 2,269 |
| qry_DeleteCCTransaction.cfm | 7/11/2002 7:22 PM | 698 |
| qry_DeleteTransaction.cfm | 7/11/2002 7:22 PM | 675 |
| qry_DeleteTransfers.cfm | 7/11/2002 7:22 PM | 697 |
| act_Profile.cfm | 7/15/2002 10:10 AM | 10,101 |
| url_Home.cfm | 7/11/2002 7:22 PM | 96 |
| dsp_ProgramPay1.cfm | 7/12/2002 5:13 PM | 3,332 |
| act_ProgramPay1.cfm | 7/12/2002 11:53 AM | 2,977 |
| url_ProgramPay1.cfm | 7/11/2002 7:22 PM | 103 |
| dsp_ProgramPay2.cfm | 7/19/2002 6:38 AM | 5,995 |
| url_ProgramPay2.cfm | 7/11/2002 7:22 PM | 103 |
| act_ProgramPay2.cfm | 7/11/2002 7:22 PM | 3,011 |
| dsp_PaymentSteps.cfm | 7/11/2002 7:22 PM | 321 |
| dsp_ProgramPay3.cfm | 7/19/2002 6:38 AM | 6,123 |
| url_ProgramPay3.cfm | 7/11/2002 7:22 PM | 103 |
| dsp_ProgramPay4.cfm | 7/17/2002 3:42 PM | 5,978 |
| act_DeleteAccount.cfm | 7/11/2002 7:22 PM | 644 |
| url_Accounts.cfm | 7/11/2002 7:22 PM | 100 |
| act_TransferMoney1.cfm | 7/12/2002 11:54 AM | 2,298 |
| dsp_TransferMoney1.cfm | 7/19/2002 6:48 AM | 4,362 |
| dsp_TransferSteps.cfm | 7/11/2002 7:22 PM | 322 |
| act_AddACHAccount.cfm | 7/11/2002 7:22 PM | 5,813 |
| url_TransferMoney1.cfm | 7/11/2002 7:22 PM | 106 |
| dsp_TransferMoney2.cfm | 7/19/2002 6:48 AM | 7,241 |
| act_AddCCAccount.cfm | 7/15/2002 10:39 AM | 6,502 |
| url_Disclosure.cfm | 7/11/2002 7:22 PM | 92 |
| act_TransferMoney2.cfm | 7/19/2002 6:49 AM | 3,014 |
| url_TransferMoney2.cfm | 7/11/2002 7:22 PM | 106 |
| dsp_TransferMoney3.cfm | 7/19/2002 6:48 AM | 6,438 |
| dsp_TransferMoney4.cfm | 7/19/2002 6:48 AM | 7,107 |
| url_TransferMoney3.cfm | 7/11/2002 7:22 PM | 106 |
| url_CPSignupDone.cfm | 7/11/2002 7:22 PM | 92 |
| dsp_CPSignupDone.cfm | 7/16/2002 4:50 PM | 1,720 |
| act_ProgramPay3.cfm | 7/12/2002 5:37 PM | 4,656 |
| act_TransferMoney3.cfm | 7/22/2002 9:06 AM | 4,457 |
| url_ScheduledTransfers.cfm | 7/11/2002 7:22 PM | 109 |
| act_ProgramPay4.cfm | 7/11/2002 7:22 PM | 11 |
| dsp_RISDFAQ.cfm | 8/2/2002 4:47 PM | 52,521 |
| Application.cfm | 7/15/2002 10:11 AM | 3,850 |
| dsp_JWULandingMenu.cfm | 7/24/2002 4:50 PM | 1,930 |
| dsp_RISDLandingMenu.cfm | 8/2/2002 4:47 PM | 3,656 |
| act_JSRedirect.cfm | 7/5/2002 11:27 AM | 297 |
| dsp_SubmitButton.cfm | 7/5/2002 1:21 PM | 689 |
| dsp_FormConfirmations.cfm | 7/5/2002 3:18 PM | 1,649 |
| 403Error.htm | 7/12/2002 4:06 PM | 4,547 |
| dsp_RISDLandingFAQ.cfm | 8/2/2002 4:47 PM | 64,087 |
| load_cm_acct_holders.cfm | 9/23/2002 2:28 PM | 3,072 |
| 1636 file(s) | | 18,198,951 |
| btn_addanother.gif | 7/19/2002 10:28 AM | 568 |
| btn_back.gif | 7/19/2002 10:28 AM | 290 |
| btn_cancel.gif | 7/19/2002 10:28 AM | 315 |
| btn_cancelmyapplication.gif | 7/19/2002 10:28 AM | 585 |
| btn_clear.gif | 7/19/2002 10:28 AM | 285 |
| btn_close.gif | 7/19/2002 10:28 AM | 579 |
| btn_continue.gif | 7/19/2002 10:28 AM | 373 |
| btn_edit.gif | 7/19/2002 10:28 AM | 255 |
| btn_exitandsave.gif | 7/19/2002 10:28 AM | 381 |
| btn_finish.gif | 7/19/2002 10:28 AM | 301 |
| btn_gethistory.gif | 7/19/2002 10:28 AM | 641 |
| btn_go.gif | 7/19/2002 10:28AM | 428 |
| btn_login.gif | 7/19/2002 10:28 AM | 305 |
| btn_mailpayment.gif | 7/19/2002 10:28 AM | 444 |
| btn_makeanother.gif | 7/19/2002 10:28 AM | 616 |
| btn_makeanothertran.gif | 7/19/2002 10:28 AM | 634 |
| btn_openaccount.gif | 7/19/2002 10:28 AM | 779 |
| btn_paytuition.gif | 7/19/2002 10:28 AM | 608 |
| btn_recalculate.gif | 7/19/2002 10:28 AM | 437 |
| btn_signup.gif | 7/19/2002 10:28 AM | 330 |
| btn_update.gif | 7/19/2002 10:28 AM | 315 |
| btn_viewprintable.gif | 7/19/2002 10:28 AM | 228 |
| glb_logo1.gif | 7/19/2002 10:28 AM | 2,537 |
| glb_logo2.gif | 7/19/2002 10:28 AM | 2,819 |
| hdr_128bit.gif | 7/19/2002 10:28 AM | 1,334 |
| hdr_accountfunding.gif | 7/19/2002 10:28 AM | 1,359 |
| hdr_accountfundingmethod.gif | 7/19/2002 10:28 AM | 760 |
| hdr_adjustments.gif | 7/19/2002 10:28 AM | 1,067 |
| hdr_campusmateadmin.gif | 7/19/2002 10:28 AM | 1,295 |
| hdr_campusmatedisclosure.gif | 7/19/2002 10:28 AM | 1,470 |
| hdr_campuspayconfirmation.gif | 7/19/2002 10:28 AM | 987 |
| hdr_campuspaydisclosure.gif | 7/19/2002 10:28 AM | 1,430 |
| hdr_campuspayhome.gif | 7/19/2002 10:28 AM | 967 |
| hdr_campuspaysignup.gif | 7/19/2002 10:28 AM | 852 |
| hdr_faq.gif | 7/19/2002 10:28 AM | 338 |
| hdr_campuspaywhattoexpect.gif | 7/19/2002 10:28 AM | 1,297 |
| hdr_cm_confirmation.gif | 7/19/2002 10:28 AM | 1,600 |
| hdr_cmlogo.gif | 7/19/2002 10:28 AM | 1,628 |
| hdr_cmlogo_landing.gif | 7/19/2002 10:28 AM | 3,382 |
| hdr_confirmation.gif | 7/19/2002 10:28 AM | 676 |
| hdr_cookiesrequired.gif | 7/19/2002 10:28 AM | 1,032 |
| hdr_cplogin.gif | 7/19/2002 10:28 AM | 1,651 |
| hdr_cpportallogin.gif | 7/19/2002 10:28 AM | 984 |
| hdr_cpwelcome.gif | 7/19/2002 10:28 AM | 1,122 |
| hdr_cpwelcomerisd.gif | 7/19/2002 10:28 AM | 2,078 |
| hdr_deferreddisclosure.gif | 7/19/2002 10:28 AM | 1,350 |
| hdr_disagreementconfirmation.gif | 7/19/2002 10:28 AM | 1,044 |
| hdr_disclosure.gif | 7/19/2002 10:28 AM | 708 |
| hdr_forgotpassword.gif | 7/19/2002 10:28 AM | 769 |
| hdr_frequentlyaq.gif | 7/19/2002 10:28 AM | 1,100 |
| hdr_fundingcheck.gif | 7/19/2002 10:28 AM | 1,569 |
| hdr_fundingcreditcard.gif | 7/19/2002 10:28 AM | 1,392 |
| hdr_fundingmethodselection.gif | 7/19/2002 10:28 AM | 1,041 |
| hdr_generalerror.gif | 7/19/2002 10:28 AM | 761 |
| hdr_identitycheckfail.gif | 7/19/2002 10:28 AM | 1,004 |
| hdr_identitycheckretry.gif | 7/19/2002 10:28 AM | 917 |
| hdr_img_help.gif | 7/19/2002 10:28 AM | 331 |
| hdr_invalidaction.gif | 7/19/2002 10:28 AM | 829 |
| hdr_invalidsection.gif | 7/19/2002 10:28 AM | 726 |
| hdr_janonresident.gif | 7/19/2002 10:28 AM | 1,288 |
| hdr_jointapplicant.gif | 7/19/2002 10:28 AM | 1,059 |
| hdr_jsdisabled.gif | 7/19/2002 10:28 AM | 1,079 |
| hdr_mailpayment.gif | 7/19/2002 10:28 AM | 1,277 |
| hdr_maketransfer.gif | 7/19/2002 10:28 AM | 886 |
| hdr_manageaccounts.gif | 7/19/2002 10:28 AM | 971 |
| hdr_myprofile.gif | 7/19/2002 10:28 AM | 728 |
| hdr_openaccount.gif | 7/19/2002 10:28 AM | 1,391 |
| hdr_nonresidentalien.gif | 7/19/2002 10:28 AM | 1,066 |
| hdr_openaccountprocesscance.gif | 7/19/2002 10:28 AM | 1,151 |
| hdr_pagenotfound.gif | 7/19/2002 10:28 AM | 889 |
| hdr_passwdsent.gif | 7/19/2002 10:28 AM | 1,096 |
| hdr_paymentconfirm.gif | 7/19/2002 10:28 AM | 914 |
| hdr_payments.gif | 7/19/2002 10:28 AM | 1,608 |
| hdr_paymentsummary.gif | 7/19/2002 10:28 AM | 1,142 |
| hdr_payoptions.gif | 7/19/2002 10:28 AM | 959 |
| hdr_pressrelease.gif | 7/19/2002 10:28 AM | 715 |
| hdr_pressreleasedetails.gif | 7/19/2002 10:28 AM | 910 |
| hdr_printworksheet.gif | 7/19/2002 10:28 AM | 1,080 |
| hdr_privacypolicy.gif | 7/19/2002 10:28 AM | 714 |
| hdr_programreports.gif | 7/19/2002 10:28 AM | 616 |
| hdr_risdpayments.gif | 7/19/2002 10:28 AM | 293 |
| hdr_saveandexit.gif | 7/19/2002 10:28 AM | 1,173 |
| hdr_servererror.gif | 7/19/2002 10:28 AM | 706 |
| hdr_scheduledtransfer.gif | 7/19/2002 10:28 AM | 1,034 |
| hdr_sessiontimeout.gif | 7/19/2002 10:28 AM | 896 |
| hdr_studentapplicant.gif | 7/19/2002 10:28 AM | 941 |
| hdr_transfermoney.gif | 7/19/2002 10:28 AM | 889 |
| hdr_transhistory.gif | 7/19/2002 10:28 AM | 894 |
| hdr_tuitionpayment.gif | 7/19/2002 10:28 AM | 887 |
| hdr_verification.gif | 7/19/2002 10:28 AM | 1,168 |
| hdr_welcome.gif | 7/19/2002 10:28 AM | 584 |
| hdr_welcomecp.gif | 7/19/2002 10:28 AM | 1,177 |
| hdr_wkshtsaved.gif | 7/19/2002 10:28 AM | 1,173 |
| home_bottom_right.gif | 7/19/2002 10:28 AM | 7,097 |
| home_foodsupplies.gif | 7/19/2002 10:28 AM | 554 |
| home_guy.gif | 7/19/2002 10:28 AM | 5,307 |
| home_guy_bottom.gif | 7/19/2002 10:28 AM | 5,664 |
| home_guy_middle.gif | 7/19/2002 10:28 AM | 9,055 |
| home_lifecampus.gif | 7/19/2002 10:28 AM | 1,222 |
| home_overview.gif | 7/19/2002 10:28 AM | 741 |
| home_middle_right.gif | 7/19/2002 10:28 AM | 7,002 |
| home_quicktour.gif | 7/19/2002 10:28 AM | 337 |
| home_relief.gif | 7/19/2002 10:28 AM | 1,460 |
| home_text_right.gif | 7/19/2002 10:28 AM | 382 |
| home_top_right.gif | 7/19/2002 10:28 AM | 7,859 |
| home_whycampus.gif | 7/19/2002 10:28 AM | 1,718 |
| img_JWUlogo_landing.gif | 7/19/2002 10:28 AM | 4,550 |
| img_JWUlogo_wizard.gif | 7/19/2002 10:28 AM | 3,876 |
| img_amex_logo.gif | 7/19/2002 10:28 AM | 2,207 |
| img_arrow_up.gif | 7/19/2002 10:28 AM | 49 |
| img_arrowgrey.gif | 7/19/2002 10:28 AM | 132 |
| img_arrowred.gif | 7/19/2002 10:28 AM | 137 |
| img_bg_cphome.gif | 7/19/2002 10:28 AM | 96 |
| img_bg_cphomecheck.gif | 7/19/2002 10:28 AM | 1,276 |
| img_bg_cphomecheck_off.gif | 7/19/2002 10:28 AM | 751 |
| img_bg_cphomeend.gif | 7/19/2002 10:28 AM | 199 |
| img_bg_hor_bottom_error.gif | 7/19/2002 10:28 AM | 44 |
| img_bg_hor_top_error.gif | 7/19/2002 10:28 AM | 44 |
| img_bg_line_yellow.gif | 7/19/2002 10:28 AM | 51 |
| img_bg_vert_left_error.gif | 7/19/2002 10:28 AM | 44 |
| img_bg_vert_right_error.gif | 7/19/2002 10:28 AM | 44 |
| img_bigcheckmark.gif | 7/19/2002 10:28 AM | 235 |
| img_bigcheckmark_empty.gif | 7/19/2002 10:28 AM | 73 |
| img_bottom_corner_menu.gif | 7/19/2002 10:28 AM | 98 |
| img_bullet.gif | 7/19/2002 10:28 AM | 47 |
| img_cplogin_line.gif | 7/19/2002 10:28 AM | 47 |
| img_dash.gif | 7/19/2002 10:28 AM | 48 |
| img_discover_logo.gif | 7/19/2002 10:28 AM | 1,683 |
| img_error_corner_bottomleft.gif | 7/19/2002 10:28 AM | 72 |
| img_{—} | 7/19/2002 10:28 AM | 72 |
| error_corner_bottomright.gif | | |
| img_error_corner_topleft.gif | 7/19/2002 10:28 AM | 72 |
| img_greencheckmark.gif | 7/19/2002 10:28 AM | 169 |
| img_error_corner_topright.gif | 7/19/2002 10:28 AM | 72 |
| img_grey.gif | 7/19/2002 10:28 AM | 43 |
| img_hdr_landingwelcome.gif | 7/19/2002 10:28 AM | 2,077 |
| img_jwu_landing.gif | 7/19/2002 10:28 AM | 26,007 |
| img_lock.gif | 7/19/2002 10:28 AM | 232 |
| img_mastercard_logo.gif | 7/19/2002 10:28 AM | 1,673 |
| img_pleaseselect.gif | 7/19/2002 10:28 AM | 1,012 |
| img_print_icon.gif | 7/19/2002 10:28 AM | 119 |
| img_print_worksheet.gif | 7/19/2002 10:28 AM | 205 |
| img_questionmark.gif | 7/19/2002 10:28 AM | 161 |
| img_risd_landing.gif | 7/19/2002 10:28 AM | 23,601 |
| img_samplecheck.gif | 7/19/2002 10:28 AM | 13,030 |
| img_smallcheckmark_off.gif | 7/19/2002 10:28 AM | 289 |
| img_smallcheckmark_on.gif | 7/19/2002 10:28 AM | 289 |
| img_step1.gif | 7/19/2002 10:28 AM | 127 |
| img_step2.gif | 7/19/2002 10:28 AM | 138 |
| img_step3.gif | 7/19/2002 10:28 AM | 143 |
| img_top_corner_menu.gif | 7/19/2002 10:28 AM | 99 |
| img_verisign.gif | 7/19/2002 10:28 AM | 3,666 |
| img_visa_logo.gif | 7/19/2002 10:28 AM | 1,530 |
| img_worksheetarrow.gif | 7/19/2002 10:28 AM | 185 |
| img_x.gif | 7/19/2002 10:28 AM | 67 |
| sec_logo.gif | 7/19/2002 10:28 AM | 2,268 |
| sec_menucorner_left.gif | 7/19/2002 10:28 AM | 80 |
| sec_menucorner_right.gif | 7/19/2002 10:28 AM | 80 |
| sec_menudot.gif | 7/19/2002 10:28 AM | 50 |
| sec_risdlogo.gif | 7/19/2002 10:28 AM | 1,173 |
| sec_risdlogo_small.gif | 7/19/2002 10:28 AM | 1,160 |
| Spacer.gif | 7/19/2002 10:28 AM | 43 |
| hdr_paymentwkconfirm.gif | 8/2/2002 6:55 PM | 1,507 |
| hdr_verifybalance.gif | 8/2/2002 6:55 PM | 1,611 |
| adj_to_statement.js | 7/19/2002 10:28 AM | 8,310 |
| common.js | 7/19/2002 10:28 AM | 7,018 |
| form_validation.js | 7/19/2002 10:28 AM | 8,542 |
| campusmate.css | 8/2/2002 6:55 PM | 13,869 |
| 167 file(s) | | 274,247 |

1. A financial funding system to facilitate funding by a parent of a plurality of financial accounts set up for a student, wherein said parent communicates with said financial funding system via the internet, said system comprising:
a client presentation layer to communicate via the internet with said parent;
a security layer to provide authentication of said parent;
a business logic layer to manage a plurality of financial accounts set up for said student and to enable said parent to transfer funds from a parent's account to selected ones of said plurality of financial accounts for the student;
an internet payment engine for electronically transferring funds from the parent's account to selected ones of said financial accounts of said student; and
a data layer for storing information about the parent, the student, the plurality of financial accounts and for keeping records of any fund transfers.

2. The financial funding system in accordance with claim 1 wherein at least some of said plurality of financial accounts are set up to fund specific expense items of a university.

3. The financial funding system in accordance with claim 2 wherein said student may communicate over the internet with said client presentation layer and may use said business logic layer to authorize payments from selected ones of said plurality of financial accounts to pay certain expense items of the university.

4. The financial funding system in accordance with claim 3 wherein said expense items may be selected from a group consisting of meals, tuition, bookstore and/or activities.

5. The financial funding system in accordance with claim 1 further comprising:
a notification layer for issuing electronic mail notification of any transfer of funds to a group consisting of the parent and/or the student.

6. The financial funding system in accordance with claim 1 further comprising:
a financial institution for maintaining and updating said plurality of financial accounts.

7. The financial funding system in accordance with claim 1 wherein said parent may fund a plurality of financial accounts set up for a plurality of students with at least some of said plurality of students enrolled at different universities.

8. A method of facilitating a parent to fund a plurality of financial accounts in a financial funding system, said parent in communication with said financial funding system via the internet, said method comprising the steps of:
receiving communications from said parent via the internet;
authenticating said parent as a registered user of the financial funding system;
providing access to the plurality of financial accounts for a student associated with the parent;
receiving authorization for amounts to be transferred into selected ones of said plurality of financial accounts of said student; and
transferring funds from an account of the parent to selected ones of said plurality of financial accounts of said student.

9. The method as claimed in accordance with claim 8 comprising the additional step of:
storing information concerning said parent, said student, said plurality of accounts in a database of the financial funding system.

10. The method as claimed in accordance with claim 8 comprising the additional step of:
keeping records of any fund transfers in a database of the financial funding system.

11. The method as claimed in accordance with claim 8 comprising the additional step of:
setting up said plurality of financial accounts to fund specific expense items of a university.

12. The method as claimed in accordance with claim 11 comprising the additional steps of:
receiving communications from said student via the internet;
authenticating said student as a registered user of the financial funding system;
providing access to the plurality of financial accounts of said student;
receiving authorization for amounts to be transferred out of selected ones of said plurality of financial accounts of said student; and
transferring funds out of selected ones of said plurality of financial accounts of said student to pay for corresponding expense items of the university.

13. The method as claimed in accordance with claim 8 comprising the additional step of:
issuing an electronic mail notification of the transfer of funds to a group consisting of the parent and/or the student.

14. The method as claimed in accordance with claim 8 comprising the additional step of:
maintaining and updating the plurality of financial accounts of said student at a financial institution.

15. The method as claimed in accordance with claim 8 comprising the additional step of:
funding a plurality of financial accounts for a second student wherein said second student is at a different university than said student.

16. The method as claimed in accordance with claim 8 comprising the additional step of:
using an internet payment engine to transfer funds from an account of said parent to selected ones of said plurality of financial accounts of said student.

17. The method as claimed in accordance with claim 12 comprising the additional step of:
using an internet payment engine to transfer funds from selected ones of said plurality of financial accounts of said student to pay for corresponding expense items of said university.
